(19) United States
(12) Patent Application Publication
(10) Pub. No.: US 2016/0371618 A1
(43) Pub. Date: Dec. 22, 2016

(54) RISK IDENTIFICATION AND RISK REGISTER GENERATION SYSTEM AND ENGINE

(71) Applicant: Thomson Reuters Global Resources, Baar (CH)

(72) Inventors: Jochen L. Leidner, London (GB); Tim Nugent, London (GB); Armineh Nourbakhsh, Brooklyn, NY (US); Sameena Shah, White Plains, NY (US)

(73) Assignee: Thomson Reuters Global Resources, Baar (CH)

(21) Appl. No.: 15/181,194

(22) Filed: Jun. 13, 2016

Related U.S. Application Data
(60) Provisional application No. 62/174,820, filed on Jun. 12, 2015.
(60) Provisional application No. 62/246,756, filed on Oct. 27, 2015.
(60) Provisional application No. 62/174,182, filed on Jun. 11, 2015.

(51) Int. Cl. G06Q 10/06; G06N 99/00; G06F 17/30

(52) U.S. Cl. CPC G06Q 10/0635; G06F 17/30327; G06N 99/005

(57) ABSTRACT

The present invention relates to a computer-based system for generating a risk register relating to a named entity. The system comprises a computing device, a risk database accessible by the computing device and having stored therein a set of risk types based on an induced taxonomy of risk types previously derived at least in part upon operation of a machine learning module, an input adapted to receive a set of source data, the set of source data being in electronic form and representing textual content comprising potential risk phrases, a entity-risk relation classifier adapted to identify and extract entity-risk relations from the set of source data, a risk tagger adapted to identify in the set of source data a set of risk candidates (rᵢ) based on the set of risk types, a entity tagger adapted to identify mentions of entity names (cᵢ) in the set of source data, and a risk register aggregator adapted to generate a first risk register based on the set of tuples associated with a first entity.

### CROSS REFERENCE TO RELATED APPLICATION

The present application claims benefit of priority to provisional applications, 62/174,820, entitled COMPUTER-SUPPORTED RISK IDENTIFICATION USING A COMPANY-RISK RELATION CLASSIFIER, filed Jun. 12, 2015; 62/246,756, entitled COMPUTER-SUPPORTED RISK IDENTIFICATION FOR THE HOLISTIC MANAGEMENT OF RISKS, filed Oct. 27, 2015; and to 62/174,182, entitled SYSTEM AND METHOD CONCERNING SUPPLY CHAIN RISK, filed Jun. 11, 2015, each of which are hereby incorporated by reference herein in their entirety.

### FIELD OF THE INVENTION

This invention generally relates to mining and intelligent processing of data collected from content sources. More specifically, this invention relates to providing data and analysis useful in risk identification using information mined from information sources, investment related trends, threats, and opportunities.

### BACKGROUND OF THE INVENTION

Organizations operate in risky environments. Competitors may threaten their markets; regulations may threaten margins and business models; customer sentiment may shift and threaten demand; and suppliers may go out of business and threaten supply. Three main areas of risk are operational, change and strategic. World events such as terrorism, natural disasters and the global financial crisis have raised the profile of negative risk while events such as the advent and widespread use of the Internet represent positive risks. Now more than ever, organizations must plan, respond and recognize all forms of risks that they face. Risk management is a central part of operations and strategy for any prudent organization and requires as a core business asset the ability to identify, understand and deal with risks effectively to increase success and reduce the likelihood of failure. Early detection and response to risks is a key need for any business and other entity.

Currently, various event alerts with respect to entities and activities are common. However, such alerts occur after the fact. While alerts as to the actual occurrence of an event which puts an entity or topic/concern at risk is important, the mining of potential risks is believed to be very useful in decision making with respect to such an entity or issue. In order to perform a meaningful risk assessment, it is often necessary to compile not only sufficient information, but information of the proper type in order to formulate a judgment as to whether the information constitutes a risk. Without the ability to access and assimilate a variety of different information sources, and particularly from a sufficient number and type of information sources, the identification, assessment and communication of potential risks is significantly hampered. Currently, gathering of risk-related information is performed manually and lacks defined criteria and processes for mining meaningful risks to provide a clear picture of the risk landscape. Additionally, known methods do not provide consistent results and may return false positives.

With the advents of the printing press, typeset, typewriting machines, computer-implemented word processing and mass data storage, the amount of information generated by mankind has risen dramatically and with an ever quickening pace. As a result of the growing and divergent sources of information, manual processing of documents and the content therein is no longer possible or desirable. Accordingly, there exists a growing need to collect and store, identify, track, classify and catalogue, and process this growing sea of information/content and to deliver value added service to facilitate informed use of the data and predictive patterns derived from such information. Due to the development and widespread deployment of and accessibility to high speed networks, e.g., Internet, there exists a growing need to adequately and efficiently process the growing volume of content available on such networks to assist in decision making. In particular the need exists to quickly process information pertaining to corporate performance and events that may have an impact (positive or negative) on such performance so as to enable informed decision making in light of the effect of events and performance, including predicting the effect such events may have on operational risk management, the price of traded securities or other offerings.

In many areas and industries, including financial services sector, for example, there are content and enhanced experience providers, such as The Thomson Reuters Corporation, Wall Street Journal, Dow Jones News Service, Bloomberg, Financial News, Financial Times, News Corporation, Zawya, and New York Times. Such providers identify, collect, analyze and process key data for use in generating content, such as reports and articles, for consumption by professionals and others involved in the respective industries, e.g., Chief Risk Officers (CROs), procurement officers, financial consultants and investors. In one manner of content delivery, these financial news services provide financial news feeds, both in real-time and in archive, that include articles and other reports that address the occurrence of recent events that are of interest to investors. Many of these articles and reports, and of course the underlying events, may have a measureable impact on the trading stock price associated with publicly traded companies. Although often discussed herein in terms of publicly traded stocks (e.g., traded on markets such as the NASDAQ and New York Stock Exchange), the invention is not limited to stocks and includes application to other forms of investment and instruments for investment and to all forms of entities, including persons, industry groups, etc. Professionals and providers in the various sectors and industries continue to look for ways to enhance content, data and services provided to subscribers, clients and other customers and for ways to distinguish over the competition. Such providers strive to create and provide enhance tools, including search and ranking tools, to enable clients to more efficiently and effectively process information and make informed decisions.

Advances in technology, including database mining and management, search engines, linguistic recognition and modeling, provide increasingly sophisticated approaches to searching and processing vast amounts of data and documents, e.g., database of news articles, financial reports, blogs, tweets, updates, SEC and other required corporate disclosures, legal decisions, statutes, laws, and regulations, that may affect business performance and, therefore, prices related to the stock, security or fund comprised of such equities. Investment and other financial professionals and other users increasingly rely on mathematical models and algorithms in making professional and business determinations. Especially in the area of investing, systems that provide faster access to and processing of (accurate) news and other information related to corporate performance will be a highly valued tool of the professional and will lead to more informed, and more successful, decision making. Information technology and in particular information extraction (IE) are areas experiencing significant growth to assist interested parties to harness the vast amounts of information accessible through pay-for-services or freely available such as via the Internet.

Many financial services providers use “news analysis” or “news analytics,” which refer to a broad field encompassing and related to information retrieval, machine learning, statistical learning theory, network theory, and collaborative filtering, to provide enhanced services to subscribers and customers. News analytics includes the set of techniques, formulas, and statistics and related tools and metrics used to digest, summarize, classify and otherwise analyze sources of information, often public “news” information. An exemplary use of news analytics is a system that digests, i.e., reads and classifies, financial information to determine market impact related to such information while normalizing the data for other effects. News analysis refers to measuring and analyzing various qualitative and quantitative attributes of textual news stories, such as that appear in formal text-based articles and in less formal delivery such as blogs and other online vehicles. More particularly, the present invention concerns analysis in the context of electronic content. Expressing, or representing, news stories as “numbers” or other data points enables systems to transform traditional information expressions into more readily analyzable mathematical and statistical expressions and further into useful data structures and other work product. News analysis techniques and metrics may be used in the context of finance and more particularly in the context of investment performance—past and predictive.

News analytics systems may be used to identify, measure and predict: operational risk management, volatility of earnings, stock valuation, markets; reversals of news impact; the relation of news and message-board information; the relevance of risk-related words in annual reports for predicting negative or positive returns; and the impact of news stories on stock returns. News analytics often views information at three levels or layers: text, content, and context. Many efforts focus on the first layer—text, i.e., text-based engines/applications process the raw text components of news, i.e., words, phrases, document titles, etc. Text may be converted or leveraged into additional information and irrelevant text may be discarded, thereby condensing it into information with higher relevance/usefulness. The second layer, content, represents the enrichment of text with higher meaning and significance embossed with, e.g., quality and veracity characteristics capable of being further exploited by analytics. Text may be divided into “fact” or “opinion” expressions. The third layer of news analytics—context, refers to connectedness or relatedness between information items. Context may also refer to the network relationships of news.

Any number of events and potential events can have a significant effect on company operations and stock price behavior. A recent example of an event affecting valuation and behavior is the explosion, and resulting oil spill disaster, of an offshore drilling platform in the Gulf of Mexico off the Louisiana coast. This event greatly affected the operations, risk management, and financial performance of several entities, including publicly traded British Petroleum (“BP”). The news of the disaster had the immediate effect of causing BP common stock to decline sharply on the day of the disaster and days following but in addition there was a range of potential risks that could result following the accident. In addition to quantifiable financial losses associated with asset damage, oil clean-up costs, claims filed by those adversely affected by the spill, BP suffered from the resulting political and social fallout. The Exxon Valdez oil tanker grounding and spill is another example. Events like these can result in legal exposure for entities related to the event and may have an associated cost of compliance for managing the event and its effects.

What is needed is a system capable of automatically processing or “reading” news stories, filings, and other content available to it and quickly interpreting the content to identify risks and to arrive at a higher understanding of assessing risks associated with an entity (company, person, industry, sector), beyond singular, scalar numeric and aggregate representations of risk. Presently, there exists a need to utilize and leverage media and other sources of entity information and a need for advanced analytics relevant to corporate performance, price behavior, investing, and reputational awareness to provide a risk-based solution. Given the vast amount of news, legal, regulatory and other entity-related information based on text, content and context, investors and those involved in financial services have a persistent need and desire for an understanding of how such vast amounts of information, even processed information, relates to actionable intelligence to foresee, plan, mitigate resource loss, and insure against risk including the likely movement of a company's stock price.

### SUMMARY OF THE INVENTION

This invention is in the area of risk management. More specifically, this invention is in the area of information and decision support systems for general computer-supported risk identification and application to supply chain risk. The present invention can extract a risk register for a company or a set of companies from a news archive such as Reuters news. It is substantially superior to the state of the art (human keyword searching) by eliminating false positives due to polysemy and contextual meaning. For example:

1. I feel fine, said Bill Gates at Microsoft;

2. Microsoft are facing a fine, said Bill Gates; and

3. (MICROSOFT IS-EXPOSED-TO FINE),

can be determined by the system of the present invention in an improved and more effective manner. More specifically, the system of the present invention can determine that the company, Microsoft, is exposed to a fine in the second example and that this is a risk, while determining the first example is not a risk for the company Microsoft and is only an expression of Bill Gates current mood. The invention also comprises a method to propagate company risks along a connected graph of supplier relationships and a graphical user interface to provide a user with visualizations related to identified risks.

The present invention provides a solution to multiple scenarios and business use cases. There are three main advantages for identifying risks associated with an entity. First, the present invention forms part of a 3rd party risk monitoring system wherein the system monitors and processes millions of sources, including media, regulatory, and enforcement sources and provides a risk score/index to an end user. The present invention assists in risk taxonomy classification and validation. It furthermore provides valuable input into determination of a risk score due to confidence level established between the risk type and the entity extracted through the process of the present invention. The present invention also enables an anti-slavery open platform which processes content from industry NGOs in structured and unstructured content by applying the same logic as stated above where the present invention will define and validate the potential risk classification and enable the processing of millions of documents in a meaningful way contributing to enriched content distribution. The present invention also frees up significant research capacity by deploying the ability to process millions of inbound alerts to validate the confidence in an alert to be researched and curated onto a database. This benefit can realize significant capacity gains calculated in terms of analyst and/or researcher hours.

The present invention comprises a system and method that can extract risk registers for companies from news archives automatically, compute and determine supply chain risk and generate a graph of supply chain relationships, and also apply the risk register generation to social media and other sources. The present invention also provides a user interface to provide a user with visualizations related to identified risks and generated risk registers.

Current systems and methods for risk identification typically involve human labour: analysts manually read news articles and populate spreadsheets, run Google searches and write down the results or use copy & paste. Additionally, keyword-based alerts may be used, but lead to information overflow of irrelevant documents (false positive problem), because a keyword search engine does not understand the content, and the keyword's context is ignored.

The present invention eliminates a major percentage of false positives over a keyword search based method. The present invention enables the processing of millions of articles in a completely automated manner with no manual effort required and solves the problem of lack of coverage of existing risk registers. Existing registers are also often stale, whereas the present invention automatically updates the registers in near real time. Moreover, an automated method also provides better scalability and higher consistency (same input->same output, unlike humans). The present invention may also incorporate data from additional social media sources, for example Weibo, a Chinese microblogging site akin to twitter with over 600 million users as of 2013. This would enable significant gains to be made in performance by increasing the coverage of side effect data.

The present invention provides different benefits based on the environment in which it is implemented. The benefit will be different for each of the use cases. For example, in extracting risk registers the present invention may be part of a more complete risk scoring process and could provide a more complete and effective system, the slavery open platform will provide an enriched content products offering that will improve the value of the open platform. The present invention may also provide for the reduction in research manual effort to process inbound alerts which would result in a cost avoidance strategy.

The present invention may be incorporated into an Enterprise Content Platform (ECP) that combines risk mining and supply chain graph information in a single database. This will provide supply chain risk mined from textual sources, and may include the results of risk mining using an SVP. The present invention may also be used as a component for event extraction application for detecting supply chain disruptions (e.g. Floods, explosions). The present invention may also be used in risk mining to automatically identify risks relating to suppliers in a supply chain.

There are known services providing preprocessing of data, entity extraction, entity linking, indexing of data, and for indexing ontologies that may be used in delivery of peer identification services. For example U.S. Pat. No. 7,333,966, entitled SYSTEMS, METHODS, AND SOFTWARE FOR HYPERLINKING NAMES (Attorney Docket No. 113027.000042US1), U.S. Pat. Pub. 2009/0198678, entitled SYSTEMS, METHODS, AND SOFTWARE FOR ENTITY RELATIONSHIP RESOLUTION (Attorney Docket No. 113027.000053US1), U.S. Pat. App. No. 12/553,013, entitled SYSTEMS, METHODS, AND SOFTWARE FOR QUESTION-BASED SENTIMENT ANALYSIS AND SUMMARIZATION, filed Sep. 02, 2009, (Attorney Docket No. 113027.000056US1), U.S. Pat. Pub. 2009/0327115, entitled FINANCIAL EVENT AND RELATIONSHIP EXTRACTION (Attorney Docket No. 113027.000058US2), and U.S. Pat. Pub. 2009/0222395, entitled ENTITY, EVENT, AND RELATIONSHIP EXTRACTION (Attorney Docket No. 113027.000060US1), the contents of each of which are incorporated herein by reference herein in their entirety, describe systems, methods and software for the preprocessing of data, entity extraction, entity linking, indexing of data, and for indexing ontologies in addition to linguistic and other techniques for mining or extracting information from documents and sources.

Systems and methods also exist for identifying and ranking documents including U.S. Pat. Pub. 2011/0191310 (Liao et al.) entitled METHOD AND SYSTEM FOR RANKING INTELLECTUAL PROPERTY DOCUMENTS USING CLAIM ANALYSIS, which is incorporated by reference herein in its entirety. Additionally, systems and methods exist for identifying entity peers including U.S. patent application Ser. No. 14/926,591, (Olof-Ors et al.) entitled DIGITAL COMMUNICATIONS INTERFACE AND GRAPHICAL USER INTERFACE, filed Oct. 29, 2015, (Attorney Docket No. 113027.000105US1) which is hereby incorporated by reference in its entirety.

Additionally, systems and methods for identifying risks and developing risk profiles include U.S. patent application Ser. No. 13/337,662, entitled METHODS AND SYSTEMS FOR GENERATING COMPOSITE INDEX USING SOCIAL MEDIA SOURCED DATA AND SENTIMENT ANALYSIS, filed Dec. 27, 2011, published as U.S. 2012/0296845,(Attorney Docket No. 113027.000069US1); U.S. patent application Ser. No. 13/337,703, entitled METHODS AND SYSTEMS FOR GENERATING CORPORATE GREEN SCORE USING SOCIAL MEDIA SOURCED DATA AND SENTIMENT ANALYSIS, filed Dec. 27, 2011, published as U.S. 2012/0316916, (Attorney Docket No. 113027.000070US1); U.S. patent application Ser. No. 13/423,127, entitled METHODS AND SYSTEMS FOR RISK MINING AND FOR GENERATING ENTITY RISK PROFILES, filed Mar. 16, 2012, published as U.S. 2012/0221485, (Attorney Docket No. 113027.000076US1); U.S. patent application Ser. No. 13/423,134, entitled METHODS AND SYSTEMS FOR RISK MINING AND FOR GENERATING ENTITY RISK PROFILES AND FOR PREDICTING BEHAVIOR OF SECURITY, filed Mar. 16, 2012, published as U.S. 2012/0221486, (Attorney Docket No. 113027.000077US1); and U.S. patent application Ser. No. 12/628,426, entitled METHOD AND APPARATUS FOR RISK MINING, filed Dec. 1, 2009, published as U.S. 2011/0131076, each of which are incorporated by reference herein in their entirety.

Incorporated by reference herein in the entirety are the following disclosures of technology and systems with which the present invention may be integrated and/or used in conjunction with: U.S. patent application Ser. No. 11/799,768, entitled METHOD AND SYSTEM FOR DISAMBIGUATING INFORMATIONAL OBJECTS issued as Pat. No. 7,953,724 (Attorney Docket No. 113027.000003US1); U.S. patent application Ser. No. 10/171,170, entitled SYSTEMS, METHODS, AND SOFTWARE FOR HYPERLINKING NAMES, issued as Pat. No. 7,333,966 (Attorney Docket No. 113027.000042US1); U.S. patent application Ser. No. 11/028,464, entitled SYSTEMS, METHODS, INTERFACES AND SOFTWARE FOR AUTOMATED COLLECTION AND INTEGRATION OF ENTITY DATA INTO ONLINE DATABASES AND PROFESSIONAL DIRECTORIES, issued as Pat. No. 7,571,174 (Attorney Docket No. 113027.000044US1); U.S. patent application Ser. No. 12/341,913, entitled SYSTEMS, METHODS, AND SOFTWARE FOR ENTITY RELATIONSHIP RESOLUTION (Attorney Docket No. 113027.000053US1); U.S. patent application Ser. No. 12/341,926, entitled SYSTEMS, METHODS, AND SOFTWARE FOR ENTITY EXTRACTION AND RESOLUTION COUPLED WITH EVENT AND RELATIONSHIP EXTRACTION (Attorney Docket No. 113027.000060US1); U.S. patent application Ser. No. 12/658,165, entitled METHOD AND SYSTEM FOR RANKING INTELLECTUAL PROPERTY DOCUMENTS USING CLAIM ANALYSIS issued as Pat. No. 9,110,971 (Attorney Docket No. 113027.000062US1); U.S. patent application Ser. No. 14/789,857, entitled METHOD AND SYSTEM FOR RELATIONSHIP MANAGEMENT AND INTELLIGENT AGENT (Attorney Docket No. 113027.000068US2); U.S. patent application Ser. No. 13/594,864, entitled METHODS AND SYSTEMS FOR MANAGING SUPPLY CHAIN PROCESSES AND INTELLIGENCE (Attorney Docket No. 113027.000081US1); U.S. patent application Ser. No. 13/914,393, entitled METHODS AND SYSTEMS FOR BUSINESS DEVELOPMENT AND LICENSING AND COMPETITIVE INTELLIGENCE (Attorney Docket No. 113027.000083US2); and U.S. patent application Ser. No. 14/726,561, entitled METHOD AND SYSTEM FOR PEER DETECTION (Attorney Docket No. 113027.0000102US1); all of which are incorporated by reference herein in their entirety.

In a first embodiment the present invention provides a computer-based system for generating a risk register relating to a named entity comprising: a computing device having a processor in electrical communication with a memory, the memory adapted to store data and instructions for executing by the processor; a risk database accessible by the computing device and having stored therein a set of risk types based on an induced taxonomy of risk types previously derived at least in part upon operation of a machine learning module; an input adapted to receive a set of source data, the set of source data being in electronic form and representing textual content comprising potential risk phrases; a entity/company-risk relation classifier adapted to identify and extract company-risk relations from the set of source data, the company-risk relation classifier comprising: a risk tagger adapted to identify in the set of source data a set of risk candidates (rᵢ) based on the set of risk types; and a entity or company tagger adapted to identify mentions of entity names (cᵢ) in the set of source data; wherein the entity-risk relation classifier maps the identified set of risk types to the identified company names to generate a set of tuples [ENTITY_{c};RISKᵣ]; and a risk register aggregator adapted to generate a first risk register based on the set of tuples associated with a first entity.

The system may further comprise wherein the identified names are stored in a entity or company index and the first risk register is associated with ENTITY_{cl}, defined as the set of all risks l . . . r . . . |R| where the entity or company index (c) is the same. The set of source data received may comprise one or more of: an indexed search; a news archive; a news feed; structured data sets; unstructured data sets; social media content; regulatory filings. The entity/company-risk relation classifier may map the set of risk types to the company names (cᵢ) in the set of source data to generate the set of tuples, the results comprising candidate risk exposure relationship tuples. The entity/company-risk relation classifier may further be adapted to filter the set of tuples to eliminate false positive tuples. The system may further comprise an output adapted to generate and transmit a risk alert in response to an update to the first risk register. The entity/company-risk relation classifier may be adapted to map the set of risk types to a plurality of entity or company names (cₗ . . . cₙ) to generate a plurality of sets of tuples tₙ) for each of the entity or company names and the risk register aggregator is further adapted to generate a plurality of risk registers (rrₗ . . . rrₙ) respectively associated with company names (cₗ . . . cₙ) and sets of tuples tₙ). The input may further be adapted to receive a search query and to execute a risk search on the plurality of risk registers (rrₗ . . . rrₙ). The system may further comprise: a risk register database adapted to store the plurality of risk registers (rrₗ . . . rrₙ); and a search engine adapted to receive and execute a search query on the plurality of risk registers (rrₗ . . . rrₙ). The system ₘay further comprise a user interface module adapted to generate for display a risk visualization inter_{f}ace representing aspects of the risk register. The company-risk relation classifier may be adapted to identify and extract company-risk relation mentions by using a set of purposₑ-defiₙed features for risk sentence classification implemented as a Support Vector Machine (SVM). The Support Vector Machine (SVM) may be trained and wherein the set of purpose-defined features is derived from a corpus of text to inform classification based on a machine learning process. The set of purpose-defined features may include a tree kernel. The company-risk relation classifier may further comprise: a supply chain risk tagger adapted to identify supply chain relationships between one or more companies identified by the entity or company tagger and to identify in the set of source data a set of supply risk candidates (srᵢ) based on a set of supply risk types associated with supply chain risks; wherein the first risk register comprises a tuple representing a supply risk type. The system may further comprise a user interface module adapted to generate for display a risk visualization interface representing a supply risk type of the first risk register. The system may further comprise a risk presentation module adapted to automatically generate a representation of risk for inclusion in a user-defined document. The user-defined document may be one of: an SEC filing; a regulatory filing; a power point presentation; a SWOT diagram; a supply-chain cluster diagram; editable text document. The entity may be selected from one of the group consisting of: a company; and a person and the expressions may be structured to conform to the particular implementation.

In a second embodiment the present invention provides a method for generating a risk register relating to a named entity comprising: receiving input from an indexed search and a news archive; creating from the input a risk taxonomy with risk types by a machine learning module; mapping the risk types to the named entity identified in the news archive, the results comprising candidate risk exposure relationship tuples; filtering the mapping results to eliminate false positive tuples; and generating in response to the identified tuples the risk register.

The method may further comprise generating a risk alert in response to an update to the risk register. The method may further comprise performing a risk search on the risk register. The method may further comprise displaying a risk visualization by representing aspects of the risk register.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is an exemplary risk identification and generation systems that employ risk mining techniques for use in implementing the present invention;

FIG. 2 is a graphical user interface representing visualizations related to supply chain risk;

FIG. 3 is a flowchart of a process for transitively identifying risk;

FIG. 4 is a flowchart representing the functional blocks of a system for generating a risk register in accordance with the present invention;

FIG. 5 is an exemplary table of feature vectors for use in accordance with the present invention;

FIG. 6 is a flowchart representing the functional blocks a system for generating a risk register in accordance with the present invention;

FIG. 7 is a flowchart representing the process of generating a risk register in accordance with the present invention;

FIG. 8 is a simple risk register and an extended risk register in accordance with the present invention;

FIG. 9 is a flowchart representing the process and functional components for generating a risk register and outputs based on the risk register in accordance with the present invention;

FIG. 10 is a set of qualitative risk types and a set of quantitative risk types associated with use in accordance with the present invention;

FIG. 11 is a risk management plan related to the set of risks in FIG. 10 in accordance with the present invention;

FIGS. 12 and 13 are flowcharts representing supply chain risk in one manner in accordance with the present invention;

FIG. 14 is a chart representing a risk portfolio;

FIG. 15 is a risk spiral diagram representing a negative risk path;

FIGS. 16-24 are a series of user interface screens and elements generated based on identified risks and generated risk registers in accordance with the present invention;

FIGS. 25 and 26 are exemplary taxonomies in accordance with the present invention;

FIGS. 27 and 28 are a risk dashboard and user interface in accordance with the present invention; and

FIG. 29 is an exemplary SWOT visualization generated based on a risk register.

### DETAILED DESCRIPTION OF THE INVENTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

A risk is a potential future event or situation that has adversarial implications; it is the possibility of something bad happening in the future. A bad event is when something that once was just a risk—whether it was recognized before or not—has materialized, i.e. it has actually happened. According to this terminology, a risk already incorporates a potential modality, and therefore it makes no sense to speak of a potential risk, as that is already implied in the risk term. Events can unfold, i.e. they can change their spatiotemporal scope, which may include other, dependent risks materializing in the process.

Risk permeates all aspects of doing business. However, to date, support tools for helping to systematically identify the whole spectrum of risks that a company is exposed to are lacking. The system of the present invention addresses these problems and is able to construct lists of risks a company faces, to be used in a qualitative assessment of risk. Existing risk management systems fail to incorporate a system or method for systematic, repeatable risk identification. The computer-supported risk identification process of the present invention comprises a more holistic risk management approach that leads to more consistent (i.e., objective, repeatable) risk analysis.

All activities of business are exposed to a broad diversity of risks: a company's business partners can engage in a lawsuit, a supplier can fail to deliver the volume or quality of the goods expected, the company location's environment can become prone to natural disasters like earthquakes, volcanoes, or human-made disasters like political instability. Additionally, the market appetite for a company's products may change, or technology disruptions may make the products superfluous altogether. Finally, the business can mismanage its customer relationships or its finances and go bankrupt. A “black swan” is a commonly used metaphor for an event that is so rare that humans might either deem it impossible, or might not be aware of it, yet one that could have tremendous impact if it were ever to materialize, and recent financial crises (e.g. 2008) and recent surge in regulatory fines (since 2014) have shown the global company ecosystem's fragility, further supporting the need for tool support. Black swans are discussed in at least N. Taleb, The Black Swan: The Impact of the Highly Improbable, Random House, 2007; Mandelbrot and N. N. Taleb, How The Finance Gurus Get Risk All Wrong, Fortune, n.a.(11):99-100, 2005; and Lorey, F. Naumann et al., Black Swan: Augmenting Statistics With Event Data, In Proceedings of CIKM 2011, Glasgow, United Kingdom, Oct. 24-28, 2011, pages 2517-2520, ACM, 2011, ISBN 978-1-4503-0717-8, each of which are incorporated by reference herein in their entirety.

Pursuing any kind of business activity is inseparably interwoven with being exposed to different kinds of risk: Is the customer I am dealing with liquid and honest, i.e. can I rely on being paid? Are my vendors delivering my supplies punctually, and to the quality I need? Am I in compliance with all applicable laws and regulations (commercial law, health & safety, financial reporting, tax, human resources etc.)? Are my products and services still relevant, or is demand shrinking or are markets disrupted by new inventions or commoditization of technologies? Are my competitors outperforming my product or undercutting my pricing? Does my business have the right staff in terms of skills? Am I setting the right priorities? Is the cash flow positive and are the profit margins acceptable? Am I exposed to currency exchange risk because many of my customers are in different currency zones? Are my offices in countries that are politically stable as well as free from natural disasters so that they can carry out their business activities in an undisturbed way? The task of finding the comprehensive set of risks faced by an entity—its risk register—is known as Risk identification. These risks and risk identification are discussed in at least U. Beck. Risk Society: Towards a New Modernity. Sage, Beverly Hills, Calif., 1992; John Adams. Risk. Routledge, 1995; Peter L. Bernstein. Against the Gods: The Remarkable Story of Risk. Wiley, 1998; and Gerd Gigerenzer. Risik Savvy: How to Make Good Decisions. Penguin, New York, N.Y., USA, 2013, each of which are incorporated herein by reference in their entirety.

The present invention computes a company's risk register as a relationship extraction task: given a company named entity mention and a mention of a risk type, the present invention classifies whether there is evidence to suggest that such a tentative pair indeed can be classified as a company risk relation instance. The present invention extracts company-risk pairs from news stories. Known methods for risk identification do not generate a company risk profile to capture a company's qualitative risk exposure. Existing systems and methods present “quantitative” studies intended to be used to exploit risk for trading rather than risk management. Similar methods are discussed in Kogan, D. Levin, B. R. Routledge, J. S. Sagi, and N. A. Smith, Predicting Risk From Financial Reports With Regression, In Proceedings of HLT-NAACL, 2009; De Saeger, K. Torisawa, and J. Kazama, Looking For Trouble, In Proceedings of the 22nd International Conference on Computational Linguistics (COLING 2008), pages 185-192, Morristown, N.J., USA, 2008, ACL. ISBN 978-1-905593-44-6; and D. Saeger, K. Torisawa, J. Kazama, K. Kuroda, and M. Murata, Large Scale Relation Acquisition Using Class Dependent Patterns, volume 0, pages 764-769, Los Alamitos, Calif., USA, 2009, IEEE Computer Society, doi: http://doi.ieeecomputersociety.org/10, 1109/ICDM.2009.140, each of which are incorporated by reference herein in their entirety.

The present invention provides the capability of automatic reasoning with respect to a supply chain. Improving upon known systems and methods, e.g. see patent publications identified in Background section above, the system computes a risk register, mines and/or generates a supply chain graph. The inventive system determines, e.g., logically inferred (i.e., reasoned), a set of risks based on a company's dependency on a set of suppliers (layer 1) who in turn depend on a set of other suppliers (layer 2), and so on. One problem in building decision support systems is the lack of complete coverage in the data expressing the dependencies; in other words, the supply chain graph is not complete. For example, Intel has two suppliers of a given part and believes it has reduced its risk by having multiple suppliers. However, and unknown to Intel, its two suppliers of the part both depend on supply of silicon product from the same source. In this instance, if anything happens to the source supplier then both of Intel's suppliers present the risk of non-supply of the part to Intel. The present invention fills gaps in the supply chain data by applying logical inference tools to the existing knowledge to create new knowledge, thus filling the gaps. The system of the present invention creates better coverage of decision support systems to help procurement specialists and risk analysts capture a complete picture of the risks an entity faces, specifically supply chain risks.

Furthermore, if evidence for a risk to one entity being an opportunity for another entity is determined, then it could be inferred that the entities are competitors. For example, the following formula could be used:

competitorOf(X, Y):-positiveRiskFor(X), negativeRiskFor(Y).

Additionally, the inverse could be performed: if it is known or determined that two companies or entities are competitors, an inference can be made for each negative risk found that an opportunity for the entity's competitors exists. Additional refinements may need to be made based on the initial inferences or reasonings as parts of companies may compete with parts of other companies. Additionally, other factors such as the effect size and exposures to and involvements in sub-areas may be included in the model to increase the model's accuracy.

In PROLOG, here are inference rules that model a fragment of such a logics:

risk(X) positiveRiskFor(X); negativeRiskFor(X);

competitorOf(X, Y):-competitorOf(Y, X);

competitorOf(X, Y):-positiveRiskFor(X), negativeRiskFor(Y);

positiveRiskFor(X):-negativeRisk(competitorOf(X));

negativeRiskFor(X):-positiveRisk(competitorOf(X));

competitorOf(X, Z):-competitorOf(X, Y), competitorOf(Y, Z);

supplierOf(X, Z):-supplierOf(X, Y), supplierOf(Y, Z);

negativeRiskFor(Y):-supplierOf(X, Y), negativeRiskFor(X);

positiveRiskFor(Y):-supplierOf(X, Y), positiveRiskFor(X).

For example, “competitorOf(X, Z) competitorOf(X, Y), competitorOf(Y, Z)” is read as “if there are three competitors X, Y, and Z, and X is a competitor for Y, and Y is a competitor of Z; then it is true that X is also a competitor of Z”. This is applying the mathematical law of transitivity to companies. The model also assumes that risks of suppliers become the risks of the supplied companies by implications and so on. The above logic also models that risks to one company may be opportunities to its competitors assuming the competition has been previously identified or may be identified. The model may also include weighting to one or more of the variables to address problems such as semantic drift, and to avoid false reasonings, improper assumptions, or probabilistic version.

Risk identification is the first step in any comprehensive risk management cycle, and to date it has been carried out for many reasons, including the following: the management of a business genuinely wants to learn about the risks that the business may suffer from, as part of business planning, project management or strategic planning activities, or just for day-to-day operational use; the business may be obliged to report risks to a regulator, for example in the case of U.S. public companies the Form 10-K filing must be annually submitted to the Securities and Exchange Commission (SEC), and it includes a section (“ITEM 7A. Quantitative and Qualitative Disclosures About Market Risk”) on risks; before an acquisition or Initial Public Offering (IPO) material risks have to be formally disclosed to potential acquiring entities and potential investors/shareholders; a person looking for a job may want to learn about the risks of a potential employer before submitting a formal application to it, to ascertain the economic viability of the company and its the adherence to his or her ethical standards (or the other way round); a bank may carry out a comprehensive risk analysis in order to establish whether or not to extend the credit line for a company that is one of their clients; or an investment manager may hold a portfolio of companies he or she has invested in, and may therefore want to ensure that the investment portfolio is risk-balanced.

The less overlap there is in the kind of risks that a portfolio is exposed to, the better.

Known methods for risk management do not comprise automated tool support for the risk identification phase of the risk management process: traditionally, people have drawn up lists or spreadsheets of business risks from scratch by convening informal meetings, typically starting out with a blank sheet. The insufficiency of risk identification has been pointed out before, notably in the context of SEC filings, where risks are often obtained from competitors' lists via copy and paste. This has a number of disadvantages. First, it is unlikely that a list created from scratch in one session is comprehensive. Second, the approach of making up the risk register in a meeting without looking at any data means the risk register will not be complete and very likely, the risks identified thus will only be the more obvious cases.

The present invention comprises a system that provides a computer-supported risk identification process. The computer-supported risk identification system accomplishes this by supporting humans with automation help in eliciting evidence for risk exposure from archives and feeds of trusted prose text, such as news, earnings call transcripts or brokerage documents.

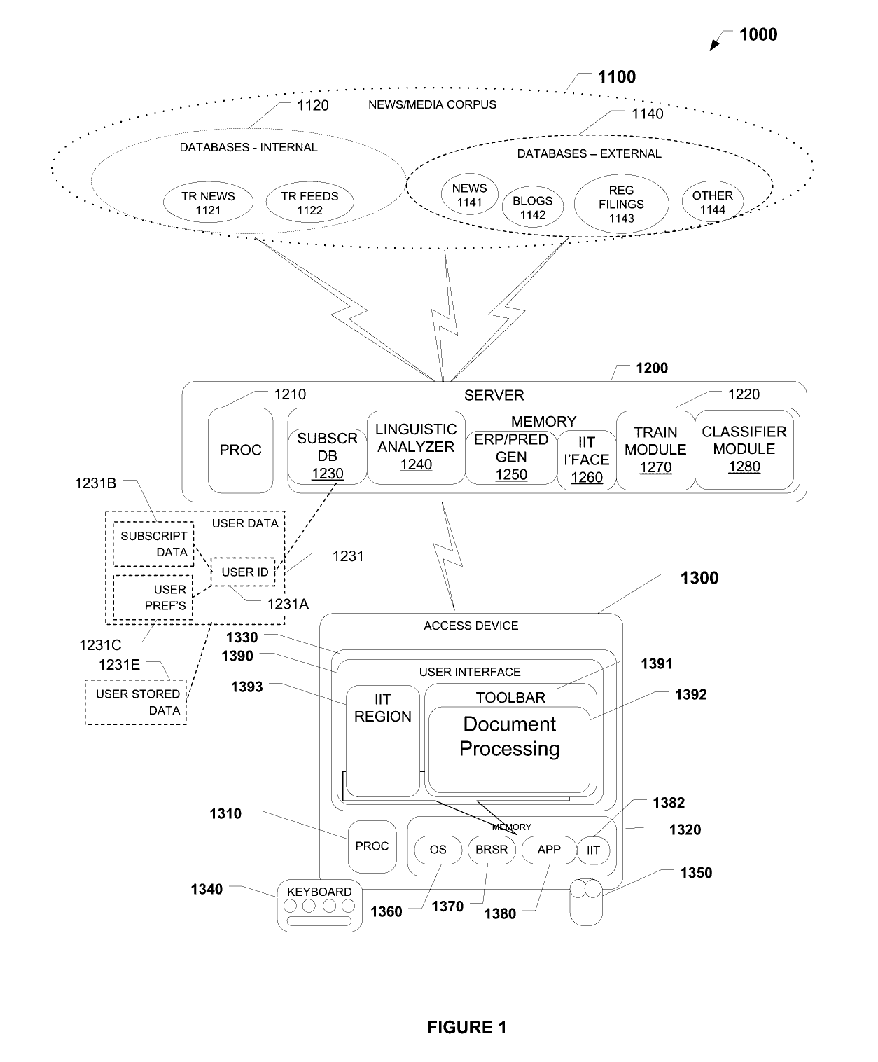

In one implementation, with reference to FIG. 1, the present invention provides a Risk Register Generation System (RRGS or “RRG system”) 1000 in the form of a news/media and other content analytics system for information extraction and is adapted to automatically process and “read” news stories and content from news, governmental filings, blogs, and other credible media sources, represented by news/media corpus 1100. Server 1200 is in electrical communication with corpus 1100, e.g., over one or more or a combination of Internet, Ethernet, fiber optic or other suitable communication means. Server 1200 includes a processor module 1210, a memory module 1220, which comprises a subscriber database 1230, a linguistic analyzer 1240, RRG module 1250, a user-interface module 1260, a training/learning module 1270 and a classifier module 1280. Processor module 1210 includes one or more local or distributed processors, controllers, or virtual machines. Memory module 1220, which takes the exemplary form of one or more electronic, magnetic, or optical data-storage devices, stores machine readable and/or executable instruction sets for wholly or partly defining software and related user interfaces for execution of the processor 1210 of the various data and modules 1230-1280.

Quantitative analysis, techniques or mathematics, such as linguistic analyzer module 1240 and RRG generation module 1250, which may also include predictive behavior determination capabilities, in conjunction with computer science methods discussed hereinbelow, are processed by processor 1210 of server 1200 to arrive at RRGs. The RRGS 1000 automatically accesses and processes news stories, filings, and other content and applies one or more computational linguistic techniques and resulting risk taxonomy against such content. The RRGS identifies risks and entities and associates risks with particular entities and scores the identified risks to generate a risk register data structure. The RRGS 1000 leverages traditional and new media resources to provide a risk-based solution that expands the scope of conventional tools to provide an enhanced analysis data structure for use by financial analysts, investment managers, risk managers and others.

The RRGS 1000 may receive as input via news media source 1141, blogs 1142, and governmental or regulatory filings source 1143 of news/media corpus 1100 content from the following exemplary content sources: news websites (reuters.com, Thomson Financial, etc); websites of governmental agencies (epa.gov); third party syndicated news (e.g. Newsroom); websites of academic institutes, political parties (mcgill.ca/mse, www.democrats.org etc); online magazine websites (emagazine.com/); blogging websites (Blogger, ExpressionEngine, LiveJournal, Open Diary, TypePad, Vox, WordPress, Xanga etc); social and professional networking sites; and information aggregators (Netvibes, Evri/Twine, etc). The invention may optionally employ other technologies, such as translators, character recognition, and voice recognition, to convert content received in one form into another form for processing by the RRGS. In this manner, the system may expand the scope of available content sources for use in identifying and scoring risks.

The RRGS 1000 of FIG. 1 includes RRG generating module 1250 adapted to process news/media information received as input via news/media corpus 1100 and to generate one or more risk registers associated with one or more entities or companies. The RRGS 1000 may include a training or learning module 1270 that analyzes past or archived news/media, and may include use of a known training set of data. In this manner the RRGS may be adapted to build one or more risk registers.

In one exemplary implementation, the RRGS 1000 may be operated by a traditional financial services company, e.g., Thomson Reuters, wherein corpus 1100 includes internal databases or sources of content 1120, e.g., TR News and TR Feeds, Newsroom, reuters.com, etc. For example, Thomson Reuters sources as the internal database may include legal sources (Westlaw), regulatory (SEC in particular, controversy data, sector specific, Etc.), social media (application of special meta-data to make it useful), and news (Thomson Reuters News) and news-like sources, including financial news and reporting. In addition, corpus 1100 may be supplemented with external sources 1140, freely available or subscription-based, as additional data points considered by the RRGS and/or predictive model. Hard facts, e.g., explosion on an oil rig results in direct financial losses (loss of revenue, damages liability, etc.) as well as negative environmental impact and resulting negative greenness score, and sentiment, e.g., quantifying the effect of fear, uncertainty, negative reputation, etc., are considered as factors that drive green scoring and/or composite environmental or green index. The news/media sentiment analysis 1250 may be used in conjunction with linguistic analyzer 1240.

In one example of how the RRGS may be further extended to process additional information, upon identifying in content obtained via TR News 1121 or TR Feeds 1122, e.g., legal reporter (e.g., Westlaw), that a company “Newco” has successfully enforced a patent (“XYZ” patent), the RRG may be updated to include as a positive risk “patent success.” This risk represents the potential for future successful efforts in further enforcing the patent against other competitors or in accounting for potential future royalties and revenues or increased margins. In presenting this risk to users, the “patent success” risk may include a link to the content from which the risk was derived.

Taking this a step further, in light of the previously referenced internal database-sourced mention concerning highly successful litigation by Newco in enforcing patent XYZ against one or more competitors, the RRG system may include additional capabilities to explore further risks associated with this principal risk. For example, external databases 1140 may include USPTO database of issued patents and the system may identify patent XYZ as being owned by Newco, e.g., assignment recordation database. (In addition, this confirms the legitimacy of the original article that claimed ownership in the XYZ patent by Newco) The system may recognize that patent XYZ names Employee as sole inventor on this and related patents. The RRGS may recognize a posting at Employee's professional networking site account that he is no longer an employee of Newco and further that he is now an employee of a competitor of Newco. Now the RRG system has two additional risks derived from an original risk. These risks may be reflected, respectively, in the RRGs for Newco and its competitor. The RRG system presents users, such as subscribers of the RRG service, with the RRG comprising the known risks for a particular entity.

In addition, the RRGS 1000 may include a classification module 1280 adapted to generate a classification system of entity risks that serves as a classification system for use in risk-based investing and that may be used to create a composite risk index. For example, companies presently assigned an RIC (Reuters Instrument Code), a ticker-like code used to identify financial instruments and indices, may be classified as “risk compliant” (e.g., achieved/maintained a risk score or profile of a certain level and/or duration). In this manner the invention may be used to create a class of risk-RICs for trading purposes. For example, a “Risk Index” may be generated and maintained comprised, for instance, of companies that have attained a risk certification or risk-RIC or the like. A risk index may attract investors interested in low risk companies or sectors.

In one embodiment the RRGS 1000 may include a training or machine learning module 1270, such as Thomson Reuters' Machine Learning Capabilities and News Analytics, to derive insight from a broad corpus of risk related data, news, and other content, and may be used on providing a normalized risk score at the company (e.g., IBM) and index level (e.g., S&P 500). This historical database or corpus may be separate from or derived from news/media corpus 1100.

In one manner, the corpus 1100 may comprise continuous feeds and may be updated, e.g., in near or close to real time (e.g., about 150 ms), allowing the RRGS to automatically analyze content, update RRGs based on “new” content in close to real-time, i.e., within approximately one second. However, the wider the scope of data used in connection with the RRGS, the longer the response time may be. To shorten the response time, a smaller window/volume of data/content may be considered. The RRGS may include the capability of generating and issuing timely intelligent alerts and may provide a portal allowing users, e.g., subscription-based analysts, to access not only the RRG and related tools and resources but also additional related and unrelated products, e.g., other Thomson Reuters products.

The RRGS 1000, powered by linguistics computational technology to process news/media data and content delivered to it, analyzes company-related news/media mentions to generate up-to-date risk registers. The quantitative and qualitative risk components provided by the RRGS 1000 may be used in market making, in portfolio management to improve asset allocation decisions by benchmarking portfolio risk exposure, in fundamental analysis to forecast stock, sector, and market outlooks, and in risk management to better understand abnormal risks to portfolios and to develop potential risk hedges.

Content may be received as an input to the RRGS 1000 in any of a variety of ways and forms and the invention is not dependent on the nature of the input. Depending on the source of the information, the RRGS will apply various techniques to collect information relevant to the generation of the risk registers. For instance, if the source is an internal source or otherwise in a format recognized by the RRGS, then it may identify content related to a particular company or sector or index based on identifying field or marker in the document or in metadata associated with the document. If the source is external or otherwise not in a format readily understood by the RRGS, it may employ natural language processing and other linguistics technology to identify companies in the text and to which statements relate.

The RRGS may be implemented in a variety of deployments and architectures. RRGS data can be delivered as a deployed solution at a customer or client site, e.g., within the context of an enterprise structure, via a web-based hosting solution(s) or central server, or through a dedicated service, e.g., index feeds. FIG. 1 shows one embodiment of the RRGS as a News/Media Analytics System comprising an online information-retrieval system adapted to integrate with either or both of a central service provider system or a client-operated processing system, e.g., one or more access or client devices 1300. In this exemplary embodiment, RRGS 1000 includes at least one web server that can automatically control one or more aspects of an application on a client access device, which may run an application augmented with an add-on framework that integrates into a graphical user interface or browser control to facilitate interfacing with one or more web-based applications.

Subscriber database 1230 includes subscriber-related data for controlling, administering, and managing pay-as-you-go or subscription-based access of databases 1100. In the exemplary embodiment, subscriber database 1230 includes one or more user preference (or more generally user) data structures 1231, including user identification data 1231A, user subscription data 1231B, and user preferences 1231C and may further include user stored data 1231E. In the exemplary embodiment, one or more aspects of the user data structure relate to user customization of various search and interface options. For example, user ID 1231A may include user login and screen name information associated with a user having a subscription to the RRG/risk scoring service distributed via RRGS 100.

Access device 1300, such as a client device, may take the form of a personal computer, workstation, personal digital assistant, mobile telephone, or any other device capable of providing an effective user interface with a server or database. Specifically, access device 1300 includes a processor module 1310 including one or more processors (or processing circuits), a memory 1320, a display 1330, a keyboard 1340, and a graphical pointer or selector 1350. Processor module 1310 includes one or more processors, processing circuits, or controllers. Memory 1320 stores code (machine-readable or executable instructions) for an operating system 1360, a browser 1370, and document processing software 1380. In the exemplary embodiment, operating system 1360 takes the form of a version of the Microsoft Windows operating system, and browser 1370 takes the form of a version of Microsoft Internet Explorer. Operating system 1360 and browser 1370 not only receive inputs from keyboard 1340 and selector 1350, but also support rendering of graphical user interfaces on display 1330. Upon launching processing software an integrated information-retrieval graphical-user interface 1390 is defined in memory 1320 and rendered on display 1330. Upon rendering, interface 1390 presents data in association with one or more interactive control features.

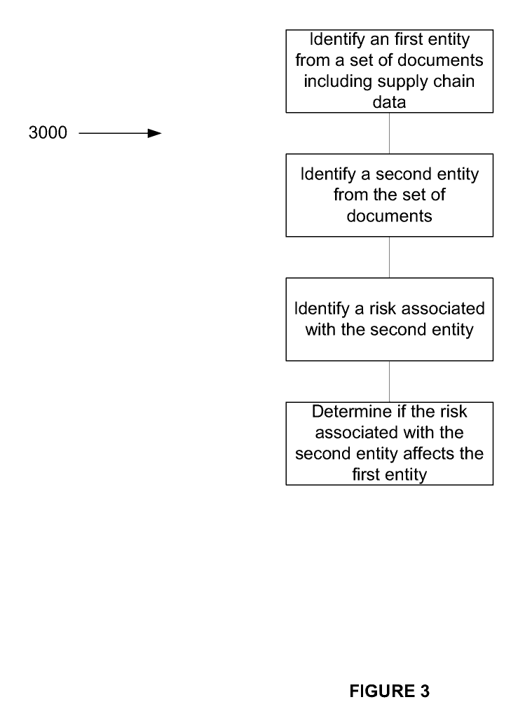

Generally, as shown in the flowchart 3000 in FIG. 3, the process for identifying entity-risk relation mentions may involve identifying a first entity from a set of documents including supply chain data, identifying a second entity from the set of documents, identifying a risk associated with the second entity, and determining if the risk associated with the second entity affects the first entity.

Doing business involves the business entity being exposed to a variety of risks, and also involves and requires recognizing, avoiding, mitigating, or insuring against these risks as an integral part of running successful business. In the area of supply chain management there are suppliers (vendors) that sell goods to companies that combine input from multiple parties, process/recombine the input and sell the processed/recombined input as output to other companies, who may also be considered suppliers themselves. This creates a large, world-wide network of dependencies. In a world of global trade and interconnectivity where specialization levels are reaching unprecedented levels, risks connected to the supply chain are an important source of potential problems that need to be monitored.

For example, a supplier of special drilling equipment to oil companies could be affected by talent attrition risk. The talent attrition risk may have the effect of placing the company's existence at risk. If the drilling equipment is solely available from a single supplier, this fact should be red-flagged and the oil company should be made aware as early as possible to take appropriate action (e.g., sourcing from a backup supplier, building their own in-house backup method/work-around, insuring).

Likewise, if a car seat manufacturer is sourcing a particular part from a supplier whose factory was destroyed unexpectedly by an earthquake, the manufacturer may break contract regarding delivering its car seats to its customer, large car companies. Yet, despite the importance of supply chain risk, there are no systematic tools that can systematically identify and alert the situations outlined above.

Supply chains, which may also be referred to as value chains, may be represented as a series of nodes and links, with each node representing an activity like the source of a material, conversion of materials into a product, intermediate storage, and point of sale/access to consumers. Links represent the routes and “containers” to move materials between nodes. Nodes and links form a company's supply chains and represent risks. Many firms have invested significant resources in building or implementing a risk management framework and supporting processes. How companies perceive and react to risks may depend on the nature of their business and distribution of products. ISO 31000 and 31010 provide one exemplary approach to identifying risks but one-size-does-not-fit-all. Finding an approach suitable to a given company's situation is complex and requires a flexible approach.

The present invention uses supply chain data (i.e., WHO supplies WHAT to WHOM) which is a prerequisite for the invention to determine supply chain risks. Supply chain data may be obtained using the following methods:
(1) purchase of commercial data sources from third party vendors;
(2) automated computer learning of a supply chain graph;
(3) found data: most companies have spreadsheets and procurement databases internally available that describe their own suppliers as well as customers. The risks that these companies (those sourced from, as well as sold to) are exposed to, is usually not well modeled.

The problem of identifying risks in the supply chain can be addressed by using a form of the transitive property or rule, for example: if a supplier of a supplier of company A has a problem, it infers that company A, too, transitively has a problem. This is true with a higher risk impact severity if there is no alternative supplier. Risk propagation rules can be used to propagate the known risks along the supply chain graph: for example, a “reputation risk” of Foxconn, a supplier of manufacturing labor services to Apple Inc, resulting from serial suicides of workers employed at Foxconn's factories because of inhumane working conditions, is a potential reputation risk also for Apple Inc., as the media may report on their business connection and its ethical implication. So clearly reputational risk can be propagated along supply chain graph connections as shown below.

% supplier relationships are transitive:

supplierOf(X, Z):-supplierOf(X, V), supplierOf(Y, Z).

% . . .

risks are propagated accordingly:

supplierRisk(Y):-risk(X), supplierOf(X, V).

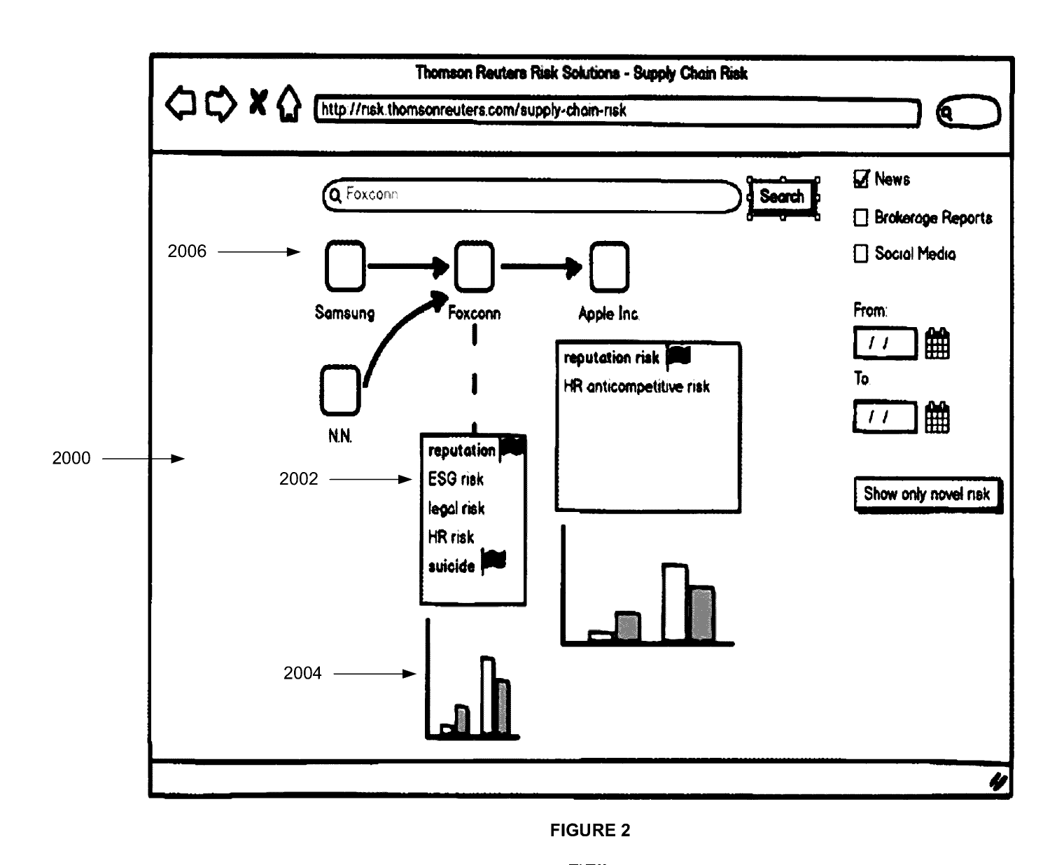

The rules used to determine the supply chain risks can be binary (true/false) logical rules, or they can be implemented with a weighting system to give appropriate consideration to certain risk or entity types, or probabilistic version. The rules may be implemented using program-like structures that can be implemented in a programming language (notably PROLOG) as well as by electronic gates and specific hardware modules. The rules can be implemented by an apparatus with a Graphical User Interface (GUI) that displays supply chain as shown in the graphical user interface 2000 in FIG. 2. The GUI 2000 may show risk registers 2002, the level of the risks in the registers 2004, and the companies in the supply chain 2006.

The present invention uses company risk classification, which comprises finding all instances of company mentions and risk type mentions. It is then determined whether the company mentioned is exposed to the risk mentioned. Specifically, the present invention comprises a supervised risk classifier that extracts company-risk relation mentions using a set of purpose-defined features defined over sentences of text. In one embodiment, the extraction may be performed by a Support Vector Machine (SVM). The relation classifier uses input from a company named entity tagger as well as input from a weakly-supervised risk type taxonomy. The SVM may be trained over a set of hand-annotated news stories from an international news agency's news archive. The company-risk relation extraction of the present invention outperforms known methods of risk extraction, and the performance of the system is primarily driven by the tree kernel. The present invention is the first system to perform automated company-risk relation extraction.

To train the SVM of the present invention, sentences in which risk phrases were annotated were randomly sampled from the Reuters News Archive (RNA) covering many different S&P 500 companies. In a pre-processing step, these sentences were tagged with company mentions and potential risk type mentions automatically as described below. Two subjects were annotated in each sentence using a binary classification scheme, where class 0 means either a sentence does not mention a risk, or the risk mentioned does not pertain to the company that the sentence is about. In the case where there is more than one company mentioned, the first company mentioned may be the one used as the focus of the risk identification.

In order to identify company-risk relation mentions there is a first taxonomy learning step that is executed offline, and only occasionally needs to be re-run to keep the list of risks (or risk universe) fresh. The taxonomy learning step generates the universe of risk type names, expressed as nouns or noun phrases. Second, at runtime, company names and risk type names are tagged in order to subsequently classify the relationship between them (what kind of risk, if any). In a further offline step, a weakly-supervised learning method is used to induce a taxonomy of risk types by applying Hearst patterns recursively over search engine result pages or the Web pages referenced in them. A process for performing this type of learning is described in at least L. Leidner and F. Schilder, Hunting For The Black Swan: Risk Mining From Text, In Proceedings of ACL 2010, pages 54-59, Uppsala, Sweden, 2010, ACL. URL http://www.aclweb.org/anthology/P10-4010, which is incorporated herein in its entirety. In one embodiment, the Yahoo! BOSS 2.0 API is used to induce a taxonomy of concept nodes.

At runtime, the learning process is iterated over all documents to be analyzed, the document is broken into sentences, the sentence is tokenized at each whitespace, and a longest-match prefix comparison is performed between the taxonomy nodes and the beginning of each token of the sentence being analysis.

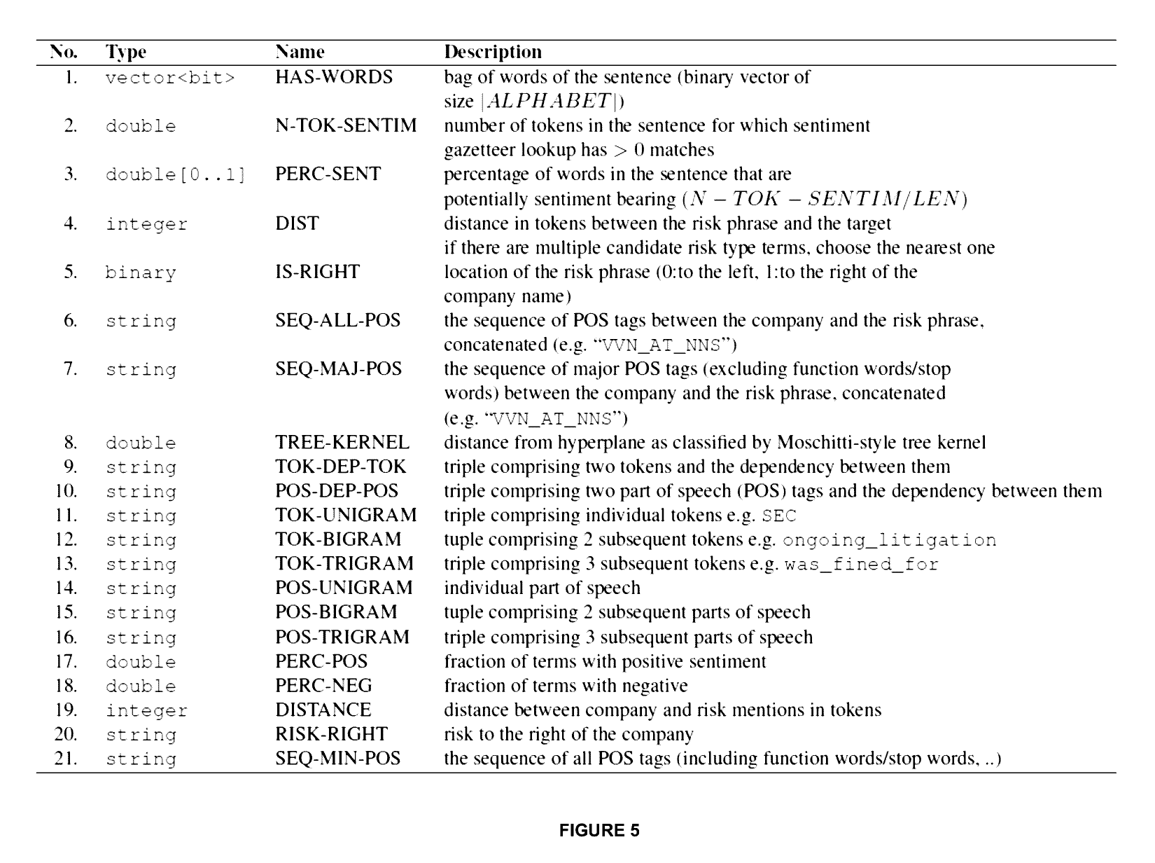

A named entity recognizer (e.g., OpenCalais) is applied to the input sentence in order to identify all mentions of company names. All possible pairs (cᵢ, rⱼ) of company names c with risk types r are generated, and a feature vector with the features shown in FIG. 5 for each of the company names and risk types is also generated. These feature vectors are passed on to the training or classification step, respectively.

A binary SVM classifier is trained on the training portion of the gold data corpus. The SVM's objective function is whether or not a particular pair of (COMPANY; RISK) mentions (e.g. (BP; oil spill risk), (JP Morgan; front running)) are (1) really used in a company and risk sense, respectively; and (2) whether the risk mentioned is actually about the company mentioned. Given a set of tuples (COMPANY_{c}; RISKᵣ) of mined company-risk relation instances, the risk register can be defined in the simplest form as the list of all risks l . . . r . . . |R|where the company index (c) is the same. The nature of risks is open-ended and changing making determination difficult. The classifier in accordance with the present invention is versatile and flexible with COMPANY of the pair being closed and RISK of the pair being open—risk is not “hard-wired,” can expand universe of risk. Good classification quality depends significantly on SVM parameter tuning. In one embodiment, the present invention uses a Subset tree (SST) kernel with a linear vector kernel; the trade-off parameter C was set to 1:0. A tree kernel multiplier of 0:1 was used, and summation was used for kernel combination. The system uses 2,160 support vectors (from 3,000 training examples), thus indicating generalization has taken place.

Machine learning is used in setting up the SVM classifier with a set of features taken from text to inform the classification. For example, FIG. 5 represents a chart of features used in the Support Vector Machine including “TREE-KERNEL,” which is the most critical feature of the feature set. The combination of all features improves accuracy and effectiveness as compared to individual features with the TREE-KERNEL feature being clearly dominant in the set.

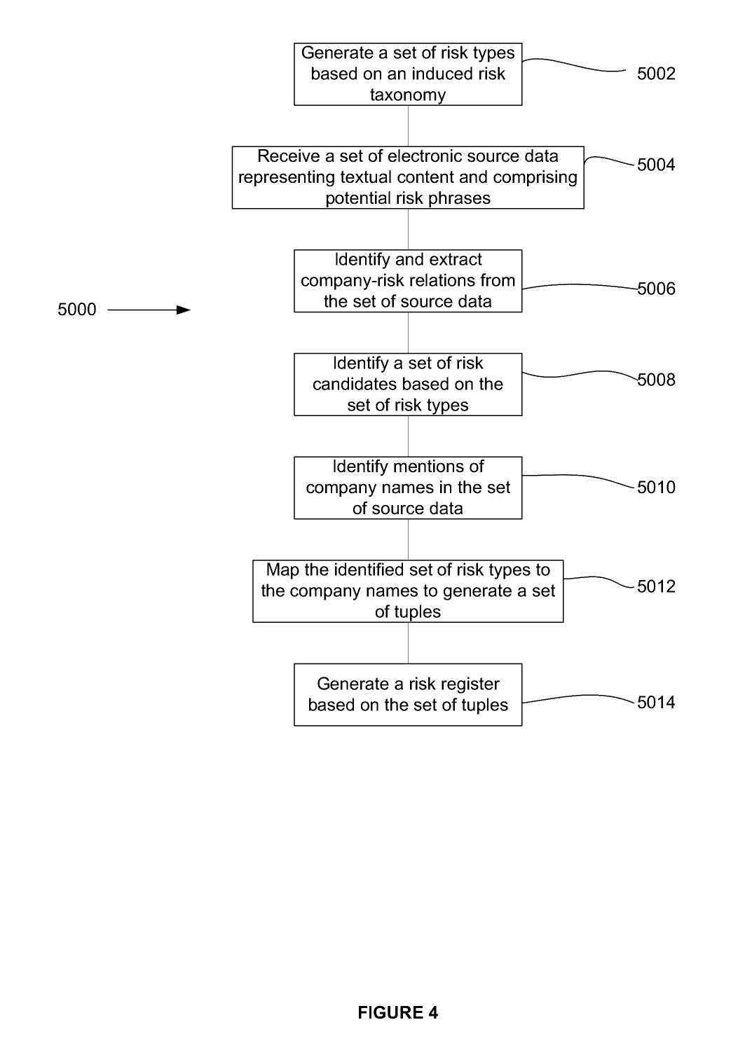

FIG. 4 shows the learning curve when inducing classifiers with training data sizes ranging from, for example, 500 to 3,000 data points (sentences). The performance stabilizes around F1=80%, so with the current model and parameters, the training data is not the limiting factor in the experimental settings.

The entity/company-risk relation mention extraction of the present invention can extract risk registers for any entity or company from a set of news stories by aggregating mentions of company-risk relations using supervised classification with a high degree of accuracy, and much more quickly and efficiently than with a naive lookup tagger. Compared to the state of the art in risk-related decision support systems, i.e. manual gathering of risk registers in a spreadsheet by a group of humans in a meeting, risk mining has the following advantages:
consistency: a computer mining risks executes in a sustained and repeatable way, and does not suffer from fatigue as human analysts do;
resilience to signal-to-noise ratio: a computer can effortlessly deal with large quantities of information, and does not mind if more than 99% of it is irrelevant, i.e. unlike any human analyst the computer does not suffer from information overload;
impartiality: unless programmed otherwise, a computer can analyze risks objectively and without bias;
speed/throughput: the computer can deal with the big data challenges of volume and velocity, i.e. it can process large quantities of text quickly and without creating a backlog;
relevance filtering: automated risk mining provides computer-supported risk identification in the form of human-machine symbiosis by providing a technology that metaphorically permits the human analyst to put on “risk glasses” that focus on the essential (risk relevant) segments of large text collections;
accountability: because the risks are identified by a deterministic method and supported by evidence linked from news stories, the process is repeatable and transparent; and
supports human cognition: compared to humans trying to identify risks.

The present invention assumes that the news stories are trustworthy. However, a credibility scoring component may be integrated to filter out or properly weight news stories or other information coming from untrustworthy information sources. The value of the company-risk relation mention extraction system of the present invention is bounded by the talk about risks contained in the news archive. In a sense, it turns the journalists into a risk analyst crowd whose collective assessment is harvested. Companies that do not get enough coverage may have vastly incomplete company risk profiles. Finally, the company-risk relation mention extraction system of the present invention focuses on risks expressed as noun phrases, but the system may be adapted to identify and analyze risks expressed using verb phrases or otherwise.

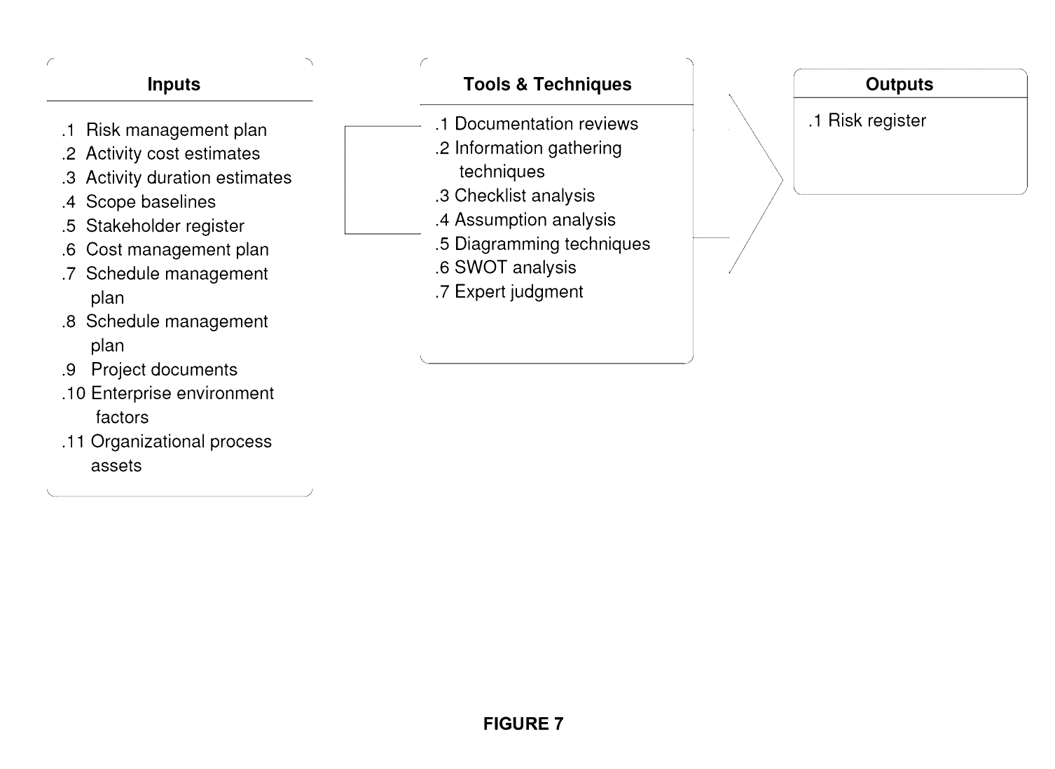

Risk identification is typically an early step in a sequence of activities including Risk Management Planning, Risk Identification, Qualitative Risk Analysis, Quantitative Risk Analysis, Risk Response Planning and Risk Monitoring and Control. However, while the importance of risk identification is acknowledged, automated tool support for the process is not provided for in existing risk management systems. The best practices in project management documented by the Project Management Institute (PMI) suggest the risk register be generated as output by a set of tools from a set of inputs as shown in FIG. 7. Participants in risk identification activities may include the following: project manager, project team members, risk management team (if assigned), customers, subject matter experts from outside the project team, end users, other project managers, stakeholders, and risk management experts. Project documents and enterprise environmental factors are listed as inputs in FIG. 7, and they include: Assumptions log; Other project information proven to be valuable in identifying risk; Published information, including commercial databases; Academic studies; Published checklists; Industry studies; and Risk attitudes. These best practices are described in at least PMI. A Guide to the Project Management Body of Knowledge (PMBOK Guide). The Project Management Institute Inc. (PMI), Newtown Square, Pa., USA, 5th edition, 2013, which is incorporated by reference herein in its entirety.

While some of these sources of evidence may include prose or text instances of risks, there is no known system or method for tool support to locate them. In known risk management systems risk register elements can lie buried within large collections of text such as news archives and the computer-supported risk identification system of the present invention is needed to unravel them. Human performed methods for risk identification include surveys of the project, customer, and users for potential concerns, and gives a list of typical project risks; clearly as of its publication date, automatic tool support for risk identification was not yet on the horizon, and it is hoped that this paper will generate initial awareness in favor of automated or semi-automated methods to collect evidence from textual data. Known methods for manually identifying risks are described in at least Harold R. Kerzner. Project Management: A Systems Approach to Planning, Scheduling, and Controlling. Wiley, 10th edition, 2009, which is incorporated by reference herein in its entirety.

The International Organization for Standardization (ISO) and the International Engineering Commission (IEC) have produced a codification of terminology and best practices for risk management, including risk identification techniques, found in ISO 31000:2009—principles and guidelines on implementation, 2009; and ISO/IEC 31010:2009—risk management—risk assessment techniques, 2009, both of which are incorporated herein by reference in their entirety. However, because the standard was issued in 2009, it predates first attempts to develop computerized tools to support the risk identification stage of the risk management process.

Key problems of risk management include (1) how to model risk, (2) how to obtain data for a chosen model so that it can be used in practice, and (3) what decisions to take based on the risks. A risk R basically has three properties to characterize it:

the risk type R_{T} : a name for the description of the risk that characterizes the nature of the adversarial potential;

a likelihood R_{L}: the estimated odds how likely the risk happens within a certain time frame (e.g., 6 months) or not;

its impact R_{I} : if it materializes, what is the severity of the damage caused. This could be expressed as minimum, expected and maximum loss in USD, for example, akin to loss databases used by insurances.

These can be expressed as: R=(R_{T} ;R_{L};R_{I}). Unfortunately, the probability of an event and its impact are often confused by laypersons and experts alike. A particularly common error is to take the frequency of mention of a risk type as a proxy for its probability: while in some cases this makes sense, for example if there are increasingly frequent reports of political unrest coming from a country, this may indeed be suggestive of an imminent civil war or revolution, in many cases the frequent mention of a risk reflects a more extensive, detailed discussion, which may actually indicate less risk (well scrutinized in this example means better understood). The computer-supported risk identification system of the present invention focuses on risk identification, however, systems and methods for risk likelihood assessment may be incorporated into the system.

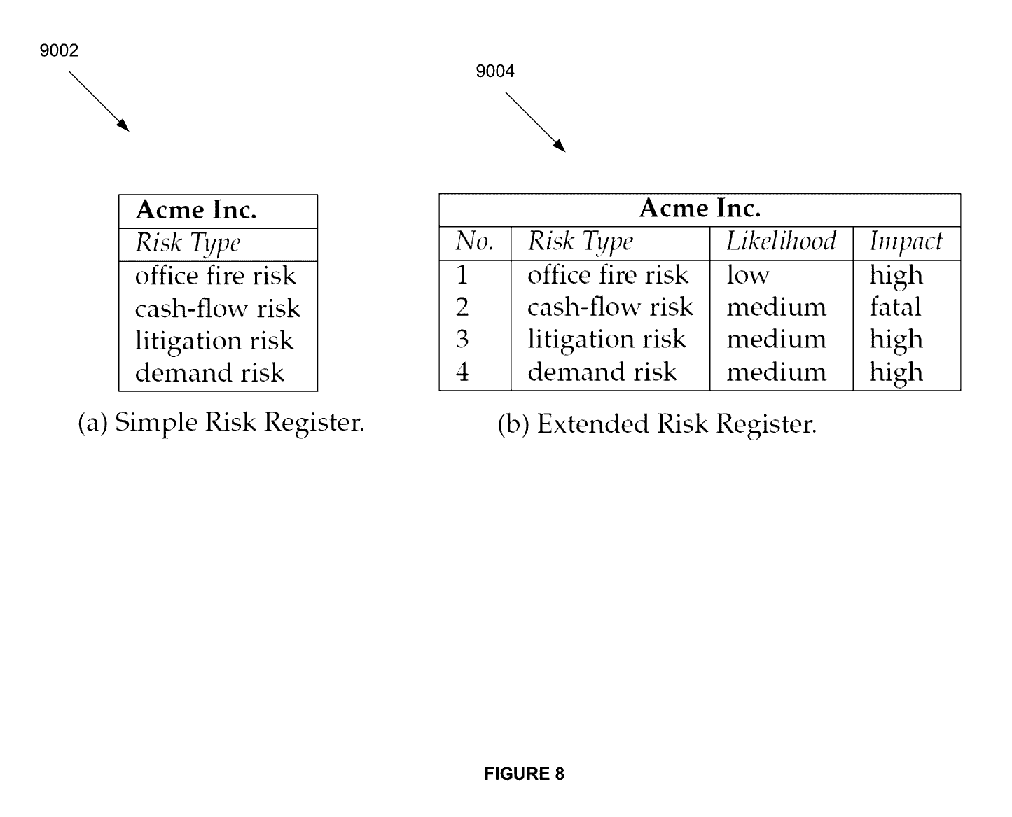

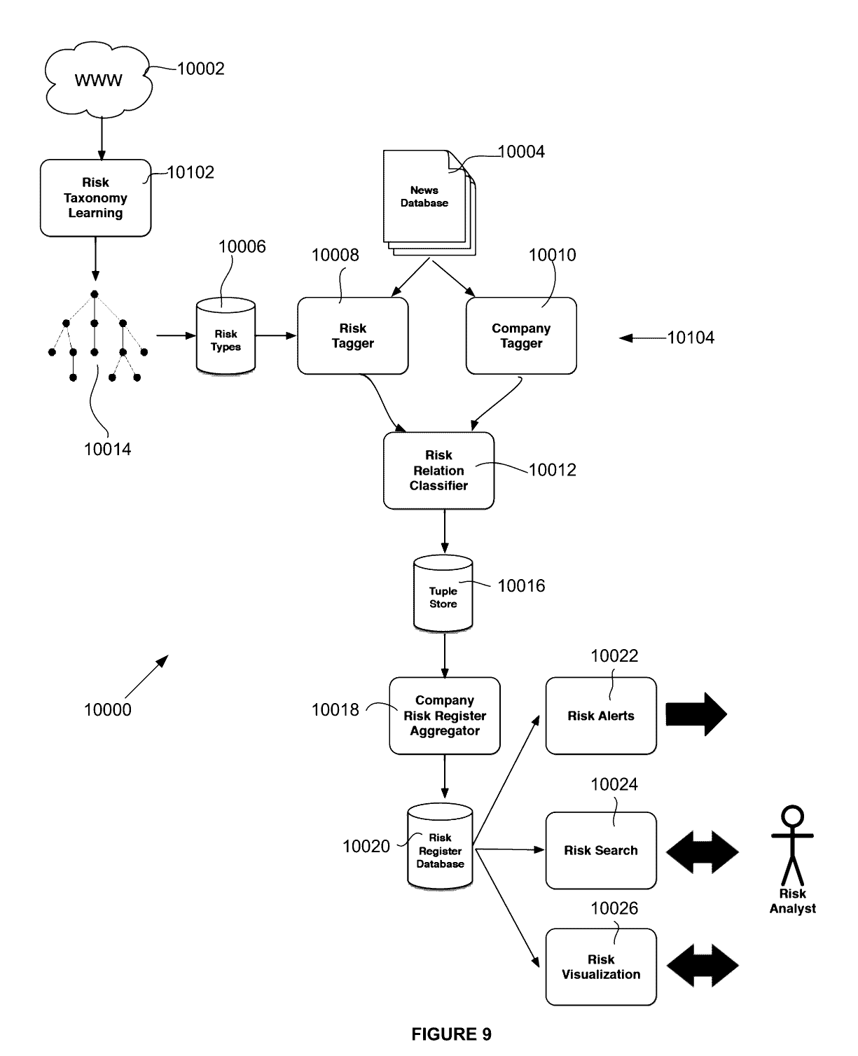

Regarding the modeling of risk, one of the easiest approaches is simply listing the risk types that a company is exposed to, the risk register shown in FIG. 8. FIG. 8 provides a Risk Register for a fictional publishing company. In its simplest form, it is a set comprising the list of risk types 9002. The extended risk register for the fictional company shows the 3 essential attributes of each risk R=(R_{T};R_{L};R_{I}) in the table 9004. The ratings “high”, “medium” and “low” in FIG. 9 are given only for didactic purposes; a real assessment should quantify risk to avoid subjective differences in interpretation of these terms. At the most sophisticated end of the spectrum, complex mathematical graph-based models could simulate propagation of risk evidence, probabilities and causality through a graph-based model. However, the present invention generates a table of intended action to deal with each risk type. More complex models may quantify probability and impact, but it is often hard to obtain data for the more complex models' parameters, and to validate its appropriateness as a model.

A risk register's value or merit can be judged along a set of dimensions including:

comprehensiveness: does it contain all or at least most risks that the entity it pertains to is exposed to? This is difficult because in reality there does not exist a complete universe of risks for an entity to compare to.

currency: does it contain the risks significantly before they materialize?

correctness: how correct are the risks in the risk register? This can be measured by Precision, the percentage of correct risks that are also present in the risk register. A risk can be deemed correct at different levels: at the most basic level, a risk Rᵢ is correctly included in a risk register for an entity e if the linguistic context from which the risk mention of r was extracted supports the inclusion decision. I.e., more human analysts would include, independently from each other, the risk in the risk register based on the evidence than those that don't (human agreement is always an upper bound of machine performance, at least if machines are evaluated against a human “ground truth”, “gold standard” or “reference solution”).

cost: all things being equal, a risk register is better than another if it can be produced more cheaply than another.

In the absence of an “oracle” that provides the complete set of risks which could be used for an absolute evaluation, one work-around is to have multiple systems developed by different groups using different methods for risk identification, each producing their own risk register for any given entity. Then the set union of all of them could be formed and reviewed by human judges, to create a resource that will be defined as the gold standard, and against which also coverage and recall can be measured to accommodate the aforementioned “completeness” quality criterion. This methodology, known as pooling, has been applied successfully in the evaluation of search engines at the US National Institute of Standards and Technology (NIST) in the Text Retrieval Conferences (TREC).

There are three types of risks that may be categorized based on a measure of the “surprise” the risks would cause if the risk materialized:

Obvious risks can be important to bring to one's attention (when their materialization is imminent), but often we will want a filter to see only the not-so-obvious;

Gray Swans are defined as risks that are hard to anticipate because they are unlikely, and they may have huge impact once they materialize; and

Black Swan risks are defined as risks that cannot in principle be anticipated, they have a very low likelihood, yet their impact is enormous (black swans were believed not to exist until some were finally discovered). If there exists a class of risks that cannot by definition be anticipated, it naturally is outside of the scope of computer supported techniques for detecting them (which is why we can focus on “gray swans” here). This is consistent with information theory's view of surprise as information content (less surprising more predictable smaller information content). White swan risks may also exist. A White Swan is, for example, a bridge that can only handle small trucks, and it can be certain that the bridge will collapse because a few big six-ton trucks can be seen coming on the highway, and so it is known that the bridge is going to collapse, it's only a matter of time. “Swans” are discussed in more detail in Jessica Pressler, Nassim Taleb: There Are Actually Three Types Of Swans, New York Magazine, 2010, (online) cited Oct. 1, 2015, http://nymag.com/daily/intelligencer/2010/06/nassim_taleb_there_are_actuall.html, which is incorporated herein by reference in its entirety.

“Risk Mining” from Textual Sources

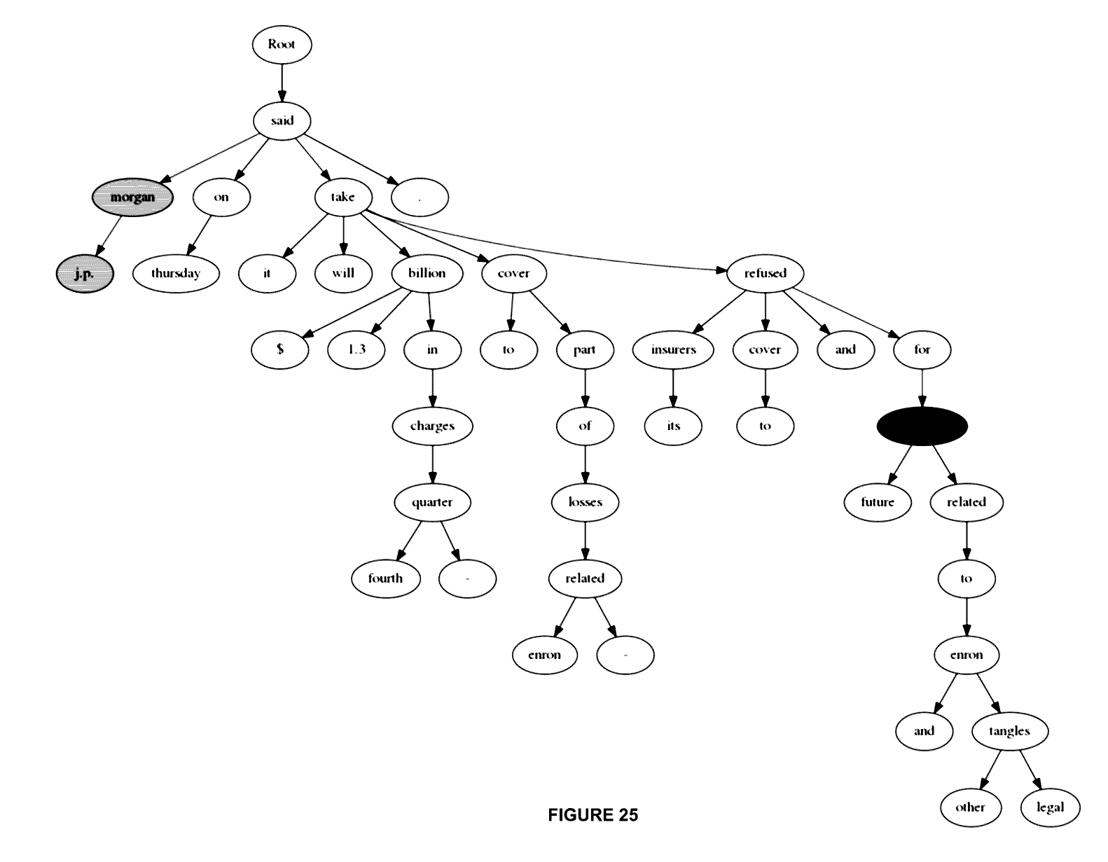

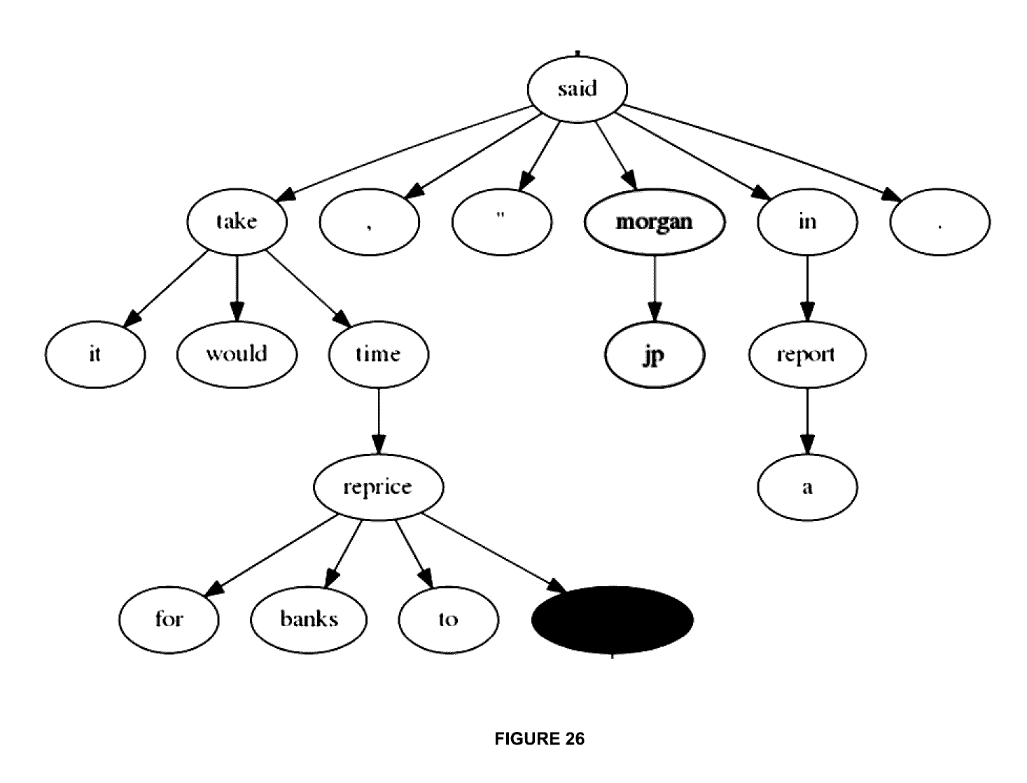

In this section, a system and method for computer-supported risk identification 10000 is described at the conceptual level as shown in FIG. 9, wherein an entity tagger tags entities, e.g., company tagger, and classifies and tags identified risk phrases to relate data to risks to which the entity is exposed. A goal is to retrieve all risks associated with an entity or company. The system takes three inputs: (i) the World Wide Web 10002, as indexed by a search engine, (ii) a set of company names, the risks of which need to be determined (e.g. a list of suppliers or an investment portfolio) and (iii) a news archive 10004 comprising trusted news and analysis. The World Wide Web (WWW) 10002 is used to mine a taxonomy of risk types 10006, examples of which are shown in FIGS. 25 and 26, regardless of the entity that is exposed to them; the WWW 10002 was chosen because it is the largest existing online source of English prose. The news archive 10004 is the source of information, from which the risks can be extracted, essentially using journalists' insights to “crowdsource” risk mentions from their reporting. The company list is the real (variable) input, and the output is a risk register for each company.

The method comprises of three steps: a taxonomy learning step 10102, which is run at least once to obtain an inventory of possible names for risks, a tagging step 10104 in which company names and risk type names, respectively, are annotated in the text of the news feed and/or news archive (by simple look-up, or possibly by a more sophisticated process such as machine learning) by a company tagger 10008 and risk tagger 10010 respectively; and a classification step performed by a risk relation classifier 10012, in which a machine learning process decides whether a risk mention instance candidate pair comprising a company name mention and a risk type mention (co-occurring in the same sentence) are indeed related to each other, and that they indeed express a risk exposure situation.

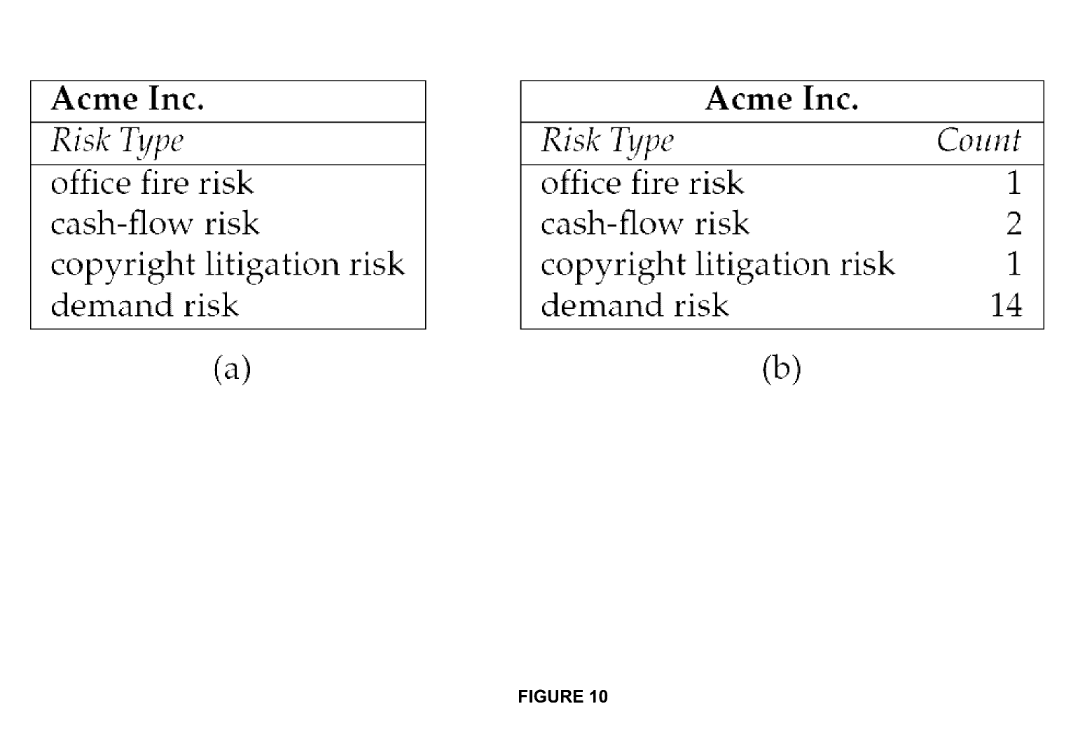

The first step creates a taxonomy of risk terms or phrases 10014, which may be referred to as the risk taxonomy. Unlike human-created taxonomy, the output is very rich in detail, but messy, “by machines, for machines” in a way. A graph is obtained with as many IS-A relationships as possible and “risk” as its root node by remote-controlling a Web search engine with search queries for linguistic patterns likely to retrieve risk terms or phrases. The method makes use of “Hearst patterns” (“financial risks such as” is likely to retrieve Web pages, in which this pattern is followed by “bankruptcy”, for instance) to induce a rich risk type vocabulary. Qualitative 11002 and Quantitative 11004 risk registers may be generated as shown in FIG. 10.

Software to automatically annotate prose text with company names is easily available today. Popular methods are based on name dictionaries (gazetteers), linguistic rules and/or machine learning. Likewise, terms and phrases from the generated risk taxonomy can be tagged or looked up in sentences. At the end of this step 10104, each sentence that contains a mention of a company name and a risk type name has both marked up in step 10104, which creates candidate pairs (tuples). In one example, the pair (Microsoft, fine) could be generated by both of the following sentences, one correct and one incorrect (i.e., undesirable in a risk mining context):

(a) Microsoft are facing a fine, said Bill Gates.

(b) I feel fine, said Microsoft's Bill Gates. Now the tuples have been formed, false positives need to be eliminated.

In order to eliminate spurious false positives in the list of candidate risk exposure relationship tuples, each pair comprising a company name and a risk term or phrase, taking into account the sentential context in which they occur, can be classified using a risk relation classifier 10012. For example, supervised machine learning is capable of distinguishing cases (a) and (b) after a few hundred training sentences have been annotated by human experts to induce a statistical model from that generalizes the evidence provided in these.

Once risk company-relation mentions have been identified and stored in the tuple store 10016, they can be aggregated by a company risk register aggregator 10018 so as to form the actual risk register to be stored in the risk register database 10020. The naive way of doing this is by forming the set of all risk mention instance tuples for each company Cᵢ i.e. to gather (Cᵢ;Rⱼ) for all js to get the risk register for one company Cᵢ.

A higher frequency indicates merely an increased number of mentions of a risk, which is not identical, but may in some cases be correlated with, a higher likelihood for the risk to materialize: a spike in mentions of “earthquake” is likely to result from imminent or actual earthquakes, but a spike in “acquisition” may or not precede the acquisition of a company; some risks are less likely to materialize just because they are mentioned often, and that is because all public focus is on the topic, so the risk is at least not overlooked.

Once a risk register is aggregated, it can be shown to a human analyst for his or her perusal as a risk alert 10022, risk search 10024, or risk visualization 10026. The risk register is regularly updated as part of the Risk Monitoring and Control activity based on new relationships mined that may not have been seen by the system before. By retrieving mentions of risks related to companies, risk mining from text supports the three goals of risk measurement according: (1) uncovering “known” risks, (2) making the known risks easier to see, and (3) trying to understand and uncover the “unknown” or unanticipated risks. The goals of risk measurement are discussed in Thomas S. Coleman, A Practical Guide to Risk Management Paperback, Research Foundation of CFA Institute, 2011, which is incorporated herein by reference in its entirety.

Case Study: Starbucks Corporation

Starbucks Corporation is a US-American coffee company that is operating coffee retail stores internationally. Civil unrest risk is perhaps not the most obvious risk type associated with this venture, yet the computer-supported risk identification system of the present invention would include this risk type in Starbucks' risk register. Is this an error? In this example, evidence shows that a Starbucks cafe was used by student protesters as a base to organize their demonstration. This makes sense as the Starbucks store is the perfect place for organizing a demo as it is centrally located, has free wireless Internet access, and serves coffee.

Once this risk type is enters the radar of the corporate risk manager of Starbucks, they can act on it. There are many ways to handle the risk (either installing house rules that ban demo organizers, or embracing the student protesters by launching a campaign “We welcome the student revolution!”); the point is that it would be unlikely that this kind of risk could be conceived using traditional risk identification techniques (i.e., a boardroom meeting with an empty Excel spreadsheet).

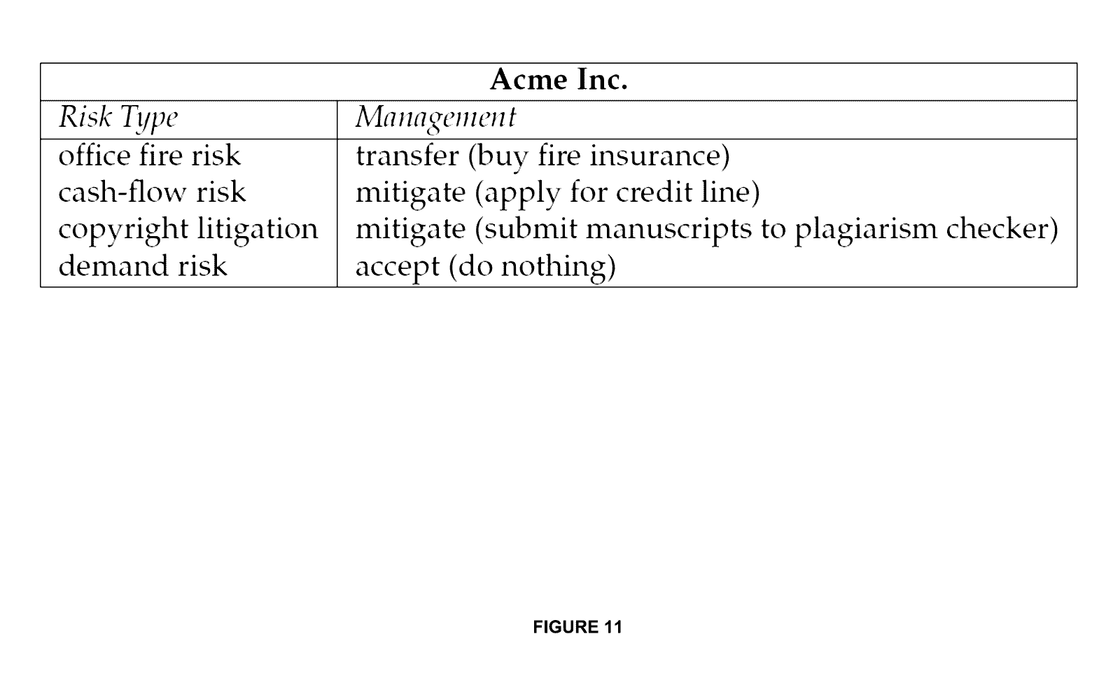

Once the risk identification, likelihood and impact assessments have concluded, a risk management plan should define the actions to be taken to influence the risks in the company's favor. An example risk management plan is shown in FIG. 11.

Risks can be investigated in isolation; however, quite often, a chain of follow-up risks is conceivable. Risk-risk connections can be causal or correlated in nature: if a country is exposed to earthquake risk, then its citizen may be exposed to hygiene risk since it is likely that water pipes may burst. The propagation of risk functions regardless of the type of risk, from hygiene risks to financial risks.

In 1995, Barings Bank failed (caused by unauthorized trading by Nick Leeson, its head derivatives trader in Singapore) due to particular risks specific only to Barings (operational risk), whereas the 2008 failure of Lehman Brothers, AIG, and others was part of a systemic meltdown of global financial systems caused by bad risk management in the real estate and credit markets. Risks can also be inherited from the geo-political environment of operations when countries are not politically stable or ridden by poverty or natural disasters. The World Economic Forum publishes an annual risk report naming the most pressing global risks.

Risk Propagation Along the Supply Chain

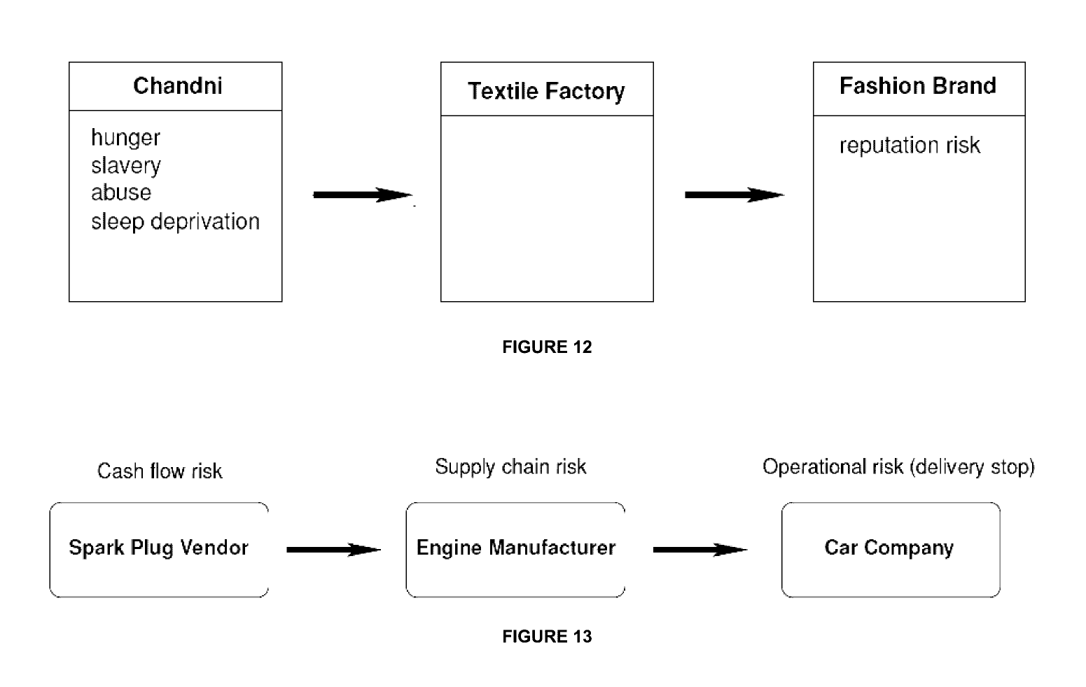

Imagine Chandni, a textile worker in an old and crowded factory building (“sweat shop”) in Bangladesh. In this hypothetical example, she earns $0.19 per hour, although she is only twelve years old. She is hungry and lacks sleep, but kept like a slave, forced to work long hours, and locked in the factory so she cannot leave. FIG. 12 shows how Chandni's personal risk register does not affect her direct employer much (if she dies, there will be another likely victim replacing her at the same cost), but the human rights violations she faces can become a reputation risk for the international fashion brand that subcontracted the textile factory that employs her.

The suicides of several employees of Foxconn (also known as Hon Hai Precision Industry Co., Ltd.), an electronics manufacturer that is a subcontractor for Apple Inc., has been a prime example of reputation damage by association. Foxconn was reported to exploit its workers, and some of them took their lives. This in turn caused outrage by Apple Inc.'s customers when reported by news media. Another example is a manufacturer of cars, which may source its engines from a vendor. The engine may contain spark plugs from yet another vendor. If the spark plug vendor produces a very customized version for the engine manufacturer that cannot easily be replaced, a cash-flow problem of the spark plug vendor may delay or even halt production for the car manufacturer if no alternatives can be sourced easily. The more remote and indirect in the supply chain graph the risk is from the company that is ultimately (transitively) exposed, the harder it is to anticipate the problem in the risk identification process. A solution could be the overlaying of risk registers onto the supply chain graph as shown in FIG. 13. For risk modeling to work very well, it ought to be connected to the real world; in the risk case, such a “calibration” means the model is more fictional.

Opposed to mere predictions, which ultimately are a form of fiction, the present system is directed to an informed-based determining process. A risk model that is informed by real-life signals, for example derived from loss databases (e.g., from the insurance sector), and project management databases (as gathered by the project management offices in corporations), will compare favorably to one that is not linked to the business operation. This connection between risk model and risk reality is bidirectional: the world informs the model, the model makes predictions, predictions are compared with real outcomes as risk do or do not materialize, and outcomes are fed back to improve models. For example, an identified cash flow risk could be measured legal by how small cash reserves become, and by comparing the current balance to the lowest previous low. Or, when identifying legal risk, actual legal services and litigation cost may be fed it back into our model. For an organization to be effective, risk modeling and risk management cannot operate separately from other parts of the business (financial, legal, operational departments).

Portfolio Risk

Given two publishing companies, Acme Inc. and Rainforest Publishing Inc., they will have very different risk registers. They share the risks common to all publishing companies, but there will be a set of risks peculiar to individual companies based on their unique name (e.g. trademark violation risk), location (demand risk), pricing (competitive risk), kind of publications offered (sourcing risk, demand risk), advertising and marketing mix (operational risk), and so on. Ed G. Reedy is a fictional investment manager in charge of 250 million US$ investment assets. At any time, he holds a portfolio of securities (e.g. shares, options, forward contracts), which make him a stakeholder in the wellbeing, and therefore also in the risk exposure, of the underlying companies that make up his portfolio.

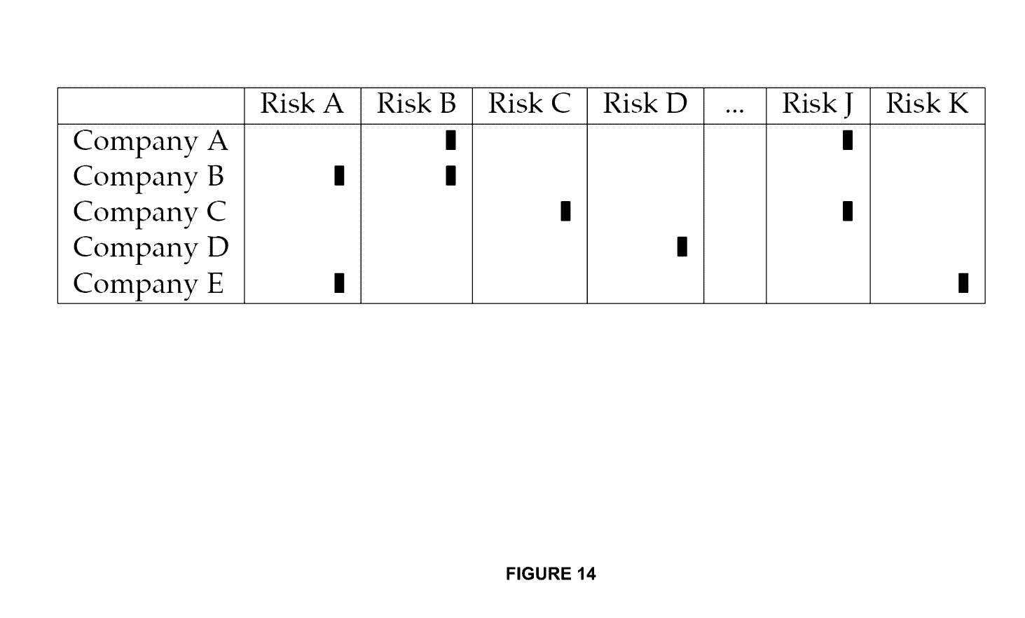

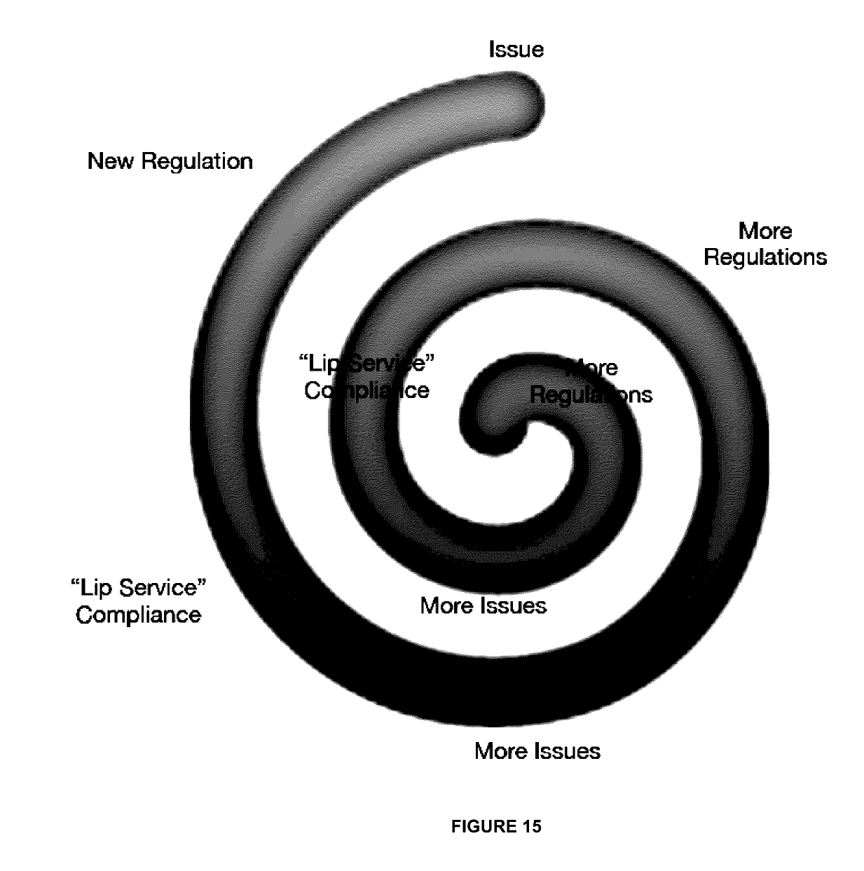

His portfolio comprises five companies, each exposed to a number of partly different, partly overlapping risks, shown in FIG. 14, and it was assembled in a way that ensures the companies have high-growth potential, and their risk as far as “fundamentals” (financial base numbers like revenue, EBITDA etc.) are not strongly correlated. Once the risk register for a company can be viewed (after extracting it from news text using risk mining, and having the output vetted by a human analyst), the portfolio risk can be scrutinized based on the qualitative risk types (as opposed to scrutinizing it based on fundamentals-based correlation only) by looking at risk overlap, to get a different perspective on risk.

With reference now to FIGS. 5 and 7, a system for generating risk registers is provided. FIG. 4 provides a flowchart 5000 comprising the functional elements executed by the system. A computer based system for generating a risk register would comprise a computing device having a processor and a memory, a risk database, an input, a company-risk relation classifier, a risk tagger, a company tagger, and a risk register aggregator. The system may also include a user interface module to generate for display a risk visualization interface representing aspects of the risk register. At block 5002 the risk database accessible by the computing device is loaded with a set of risk types generated based on an induced risk taxonomy previously derived at least in part upon operation of a machine learning module. At block 5004 the input receives a set of electronic source data representing textual content and comprising potential risk phrases. The set of source data received comprises one or more of: an indexed search; a news archive; a news feed; structured data sets; unstructured data sets; social media content; regulatory filings. The input may also receive a search query and to execute a risk search on the plurality of risk registers (rrₗ . . . rrₙ)

At blocks 5006-5012, a company-risk relation classifier, which comprises a risk tagger and a company tagger, identifies and extracts company-risk relations from the set of source data. At block 5008, the risk tagger identifies in the set of source data a set of risk candidates (rᵢ) based on the set of risk types. At block 5010, the company tagger identifies mentions of company names (cᵢ) in the set of source data. The identified names are stored in a company index and the first risk register is associated with COMPANY_{cl}, defined as the set of all risks l . . . r . . . |R| where the company index (c) is the same. At block 5012 the company-risk relation classifier maps the identified set of risk types to the identified company names to generate a set of tuples [COMPANY_{c};RISKᵣ]. Although described herein in terms of company-risk relationship, the invention applies broadly to any type of entity, e.g., company or person, etc. The expressions used herein are more broadly considered in the forms of entity names (cᵢ) and [ENTITY_{c};RISKᵣ]. The company-risk relation classifier maps the set of risk types to the company names (cᵢ) in the set of source data to generate the set of tuples, the results comprising candidate risk exposure relationship tuples. The company-risk relation classifier may further filter the set of tuples to eliminate false positive tuples. The company-risk relation classifier may further map the set of risk types to a plurality of company names (cₗ . . . cₙ) to generate a plurality of sets of tuples (tₗ . . . tₙ) for each of the company names and generate a plurality of risk registers (rrₗ . . . rrₙ) respectively associated with company names (cₗ. . . cₙ) and sets of tuples (tₗ . . . tₙ). The company-risk relation classifier may also identify and extract company-risk relation mentions by using a set of purpose-defined features for risk sentence classification implemented as a trained Support Vector Machine (SVM) and the set of purpose-defined features may be derived from a corpus of text to inform classification based on a machine learning process. The set of purpose-defined features may include a Moschitti-style tree kernel.

In addition to the risk and company taggers, the company-risk relation classifier may also comprise a supply chain risk tagger adapted to identify supply chain relationships between one or more companies identified by the company tagger and to identify in the set of source data a set of supply risk candidates (srᵢ) based on a set of supply risk types associated with supply chain risks.

Finally, at block 5014, the risk register aggregator generates a first risk register based on the set of tuples associated with a first company that may include a tuple representing a supply risk type. A risk alert may be generated and transmitted in response to an update of the first risk register. The system may further comprise a risk register database adapted to store the plurality of risk registers (rrₗ . . . rrₙ); and a search engine adapted to receive and execute a search query on the plurality of risk registers (rrₗ . . . rrₙ). The system may output any information generated by the system using a risk presentation module adapted to automatically generate a representation of risk for inclusion in a user-defined document which may be one of: an SEC filing; a regulatory filing; a power point presentation; a SWOT diagram; a supply-chain cluster diagram; editable text document.

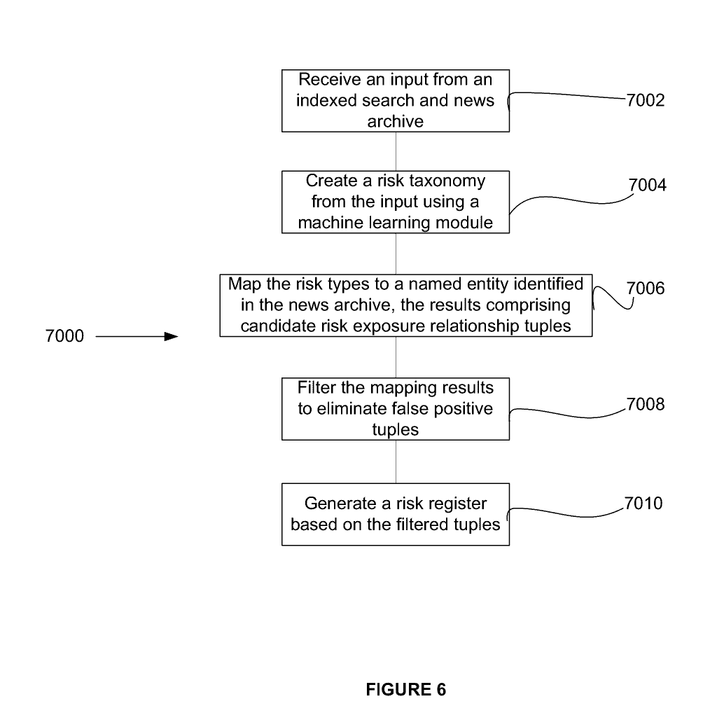

With reference now to FIG. 6, a flowchart 7000 representing system for generating a risk register relating to a named entity is provided. In block 7002 the system receives input from an indexed search and a news archive. In block 7004 the system creates from the input a risk taxonomy with risk types by a machine learning module. At block 7006 the system maps the risk types to the named entity identified in the news archive, the results comprising candidate risk exposure relationship tuples. At block 7008 the system filters the mapping results to eliminate false positive tuples and in block 7010 the system generates in response to the identified tuples the risk register. The system may also generate a risk alert in response to an update to the risk register, perform a search on the risk register, and display a risk visualization by representing aspects of the risk register as described below. A search engine may be used to integrate services and provide user interface to facilitate searching of risks for entities of interest or for risk types of interest. A clustering module may be used to cluster based on industry or risk type and provide visualization of relationships among entities.

Graphical User Interface

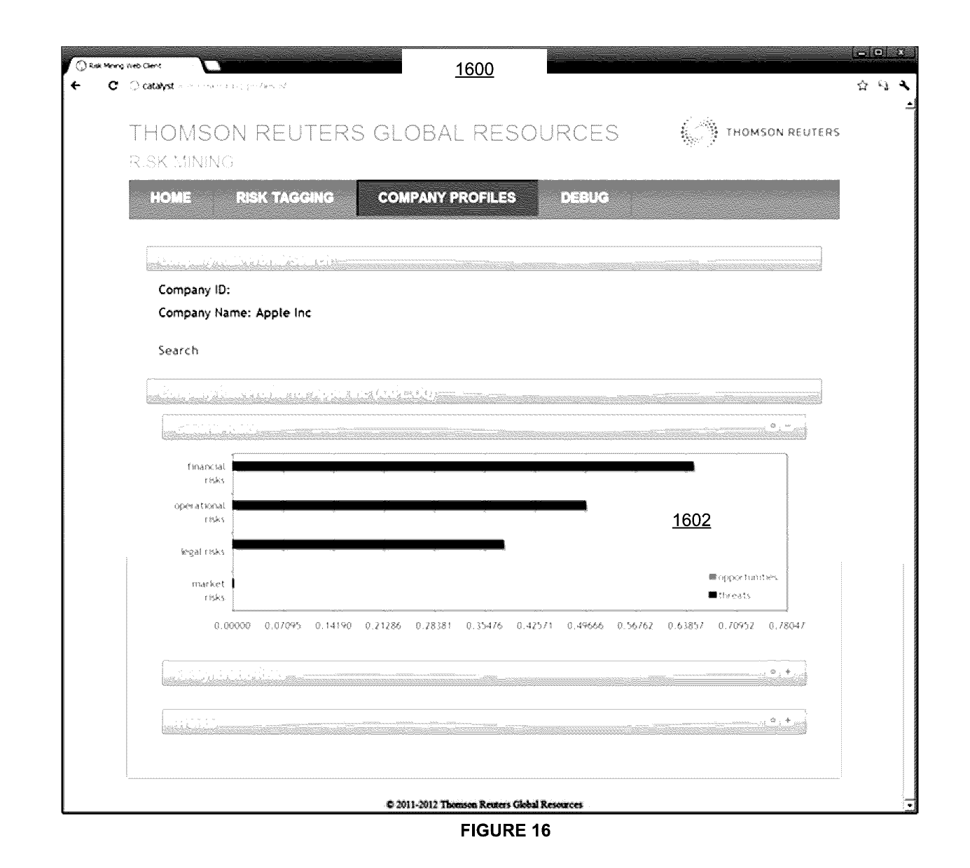

With reference now to FIGS. 16-29, a set of screenshots of a graphical user interface and visualizations for display in the graphical user interface are provided. The elements shown in FIGS. 16-29 may be provided as part of a single risk identification and management system and graphical user interface or may be integrated separately into other risk management systems. FIG. 16 provides a graphical user interface 1600 showing a set of general risks comprising financial risks, operational risks, legal risks, and market risks for an entity, Apple Inc. The risks shown are represented by a numerical value in a bar graph 1602. The graph 1602 also provides an indication as to whether the risks are opportunities or threats. The graphical user interface 1600 may also show idiosyncratic risks and trends associated with the entity, Apple Inc. A user is allowed to search by entity (e.g., company) name, entity ID, and may restrict search using other parameters, e.g., date range. Risk types (risks extracted and classified) avoid false positives.

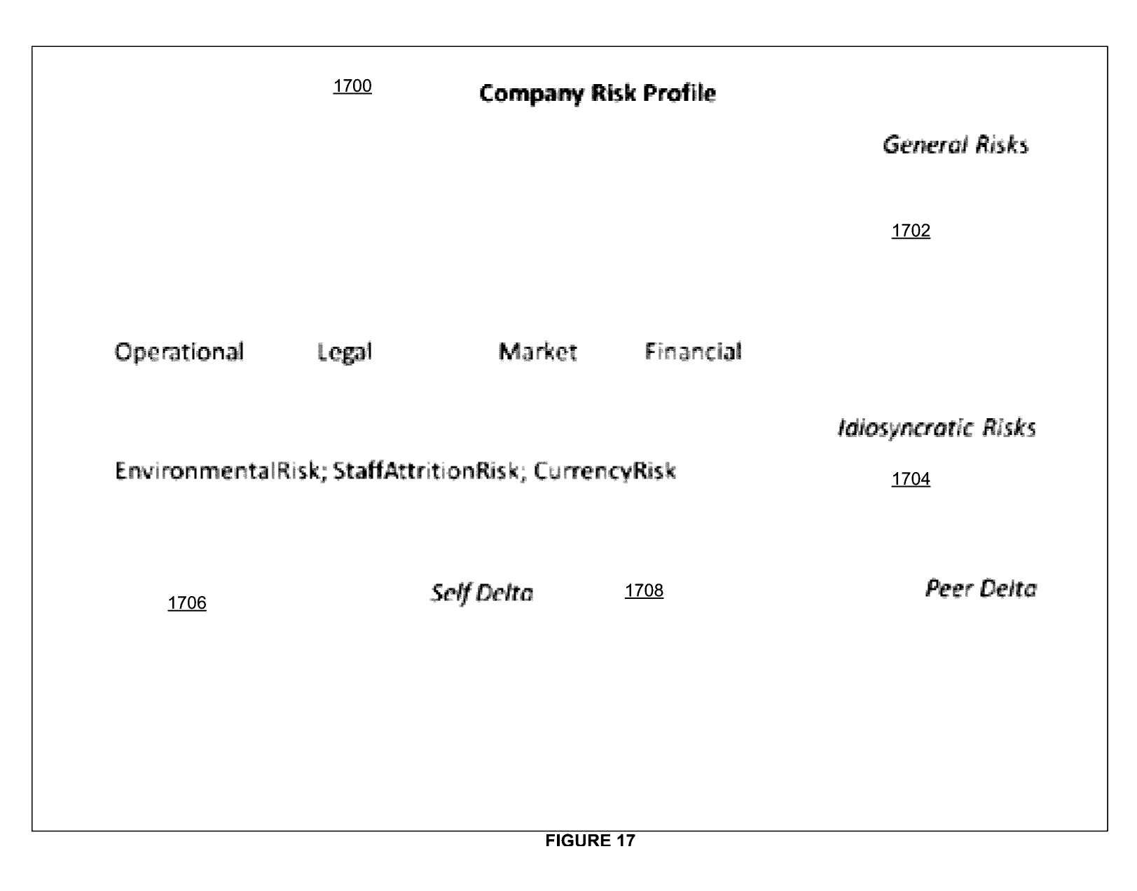

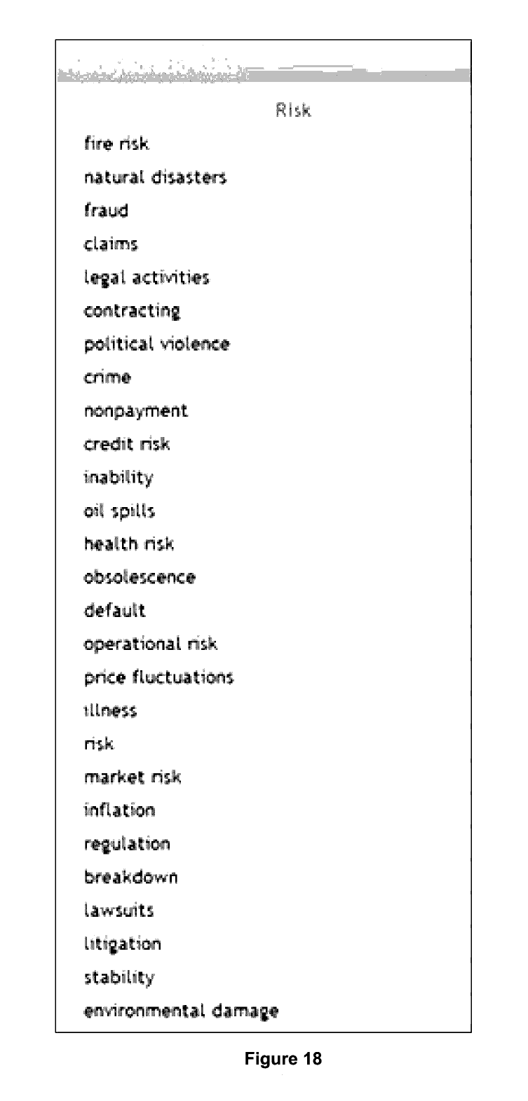

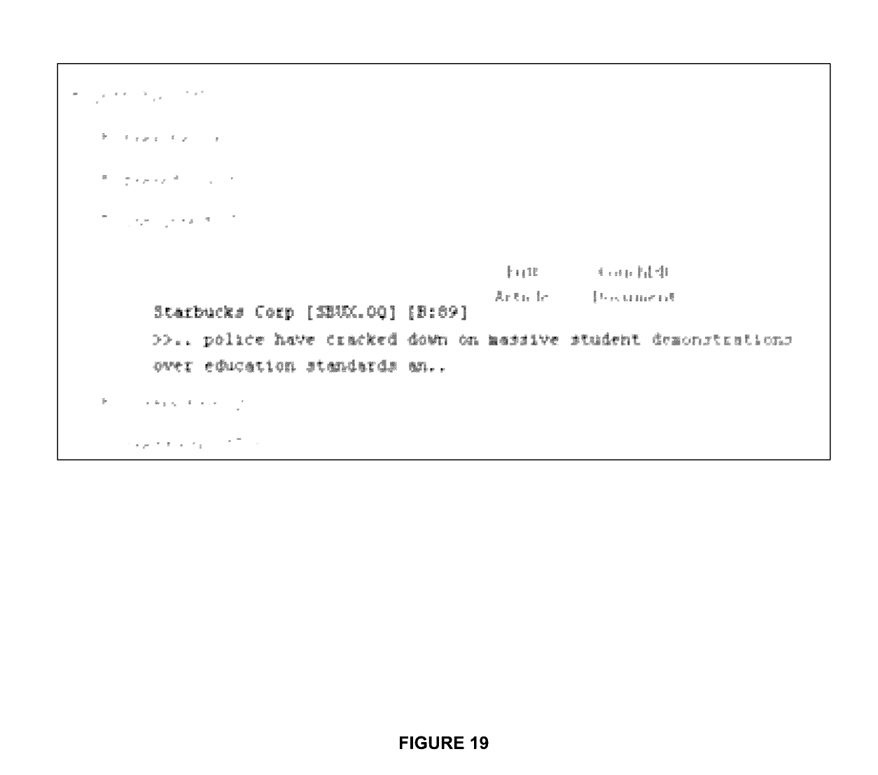

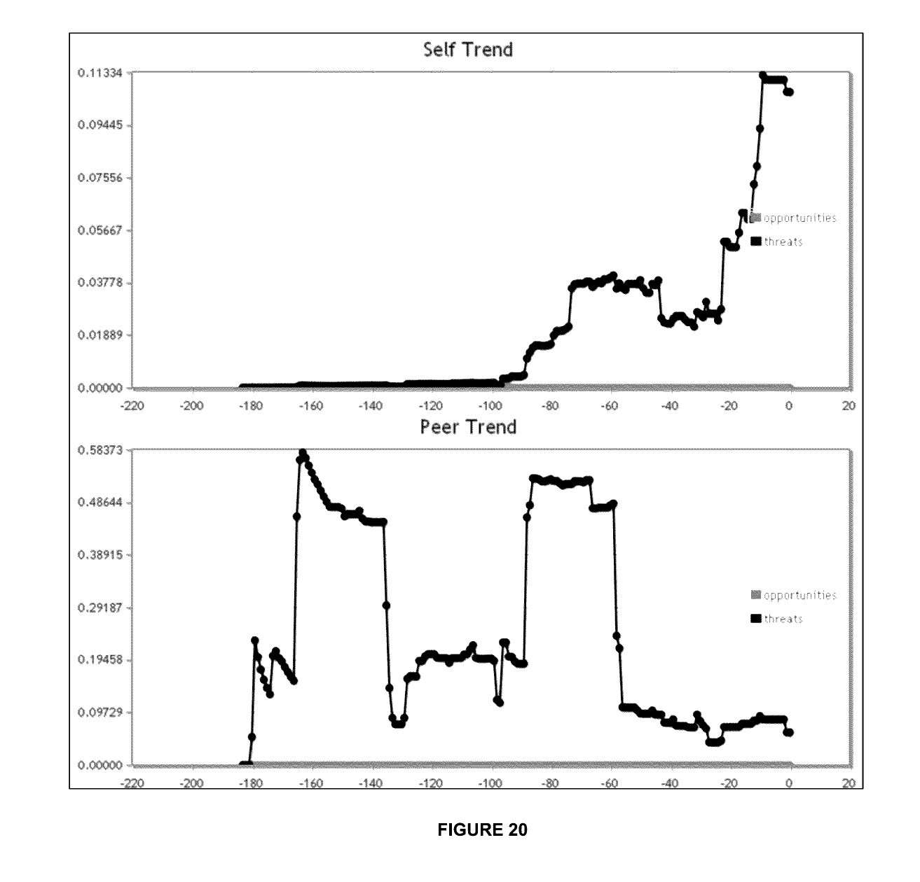

FIG. 17 provides a graphical representation of a company risk profile 1700. The risk profile may show a set of general risks 1702 including operational, legal, market, and financial risks, a set of idiosyncratic risks 1704 including environmental risks, staff attrition risks, and currency risk, and graphical representations of self delta (self trend) 1706, and peer delta (peer trend) 1708. The self trend 1706 and peer trend 1708 may be selected and seen in greater detail as shown in FIG. 20. FIG. 18 provides a list of idiosyncratic risks that may be associated with an entity. One or more of the risks may be selected to view additional data including graphical representations of the risks. For example, as shown in FIG. 19 a “civil unrest” risk may be selected to view additional information on how the risk was determined. Additional information such as related articles and documents may be accessed when the risk is selected.

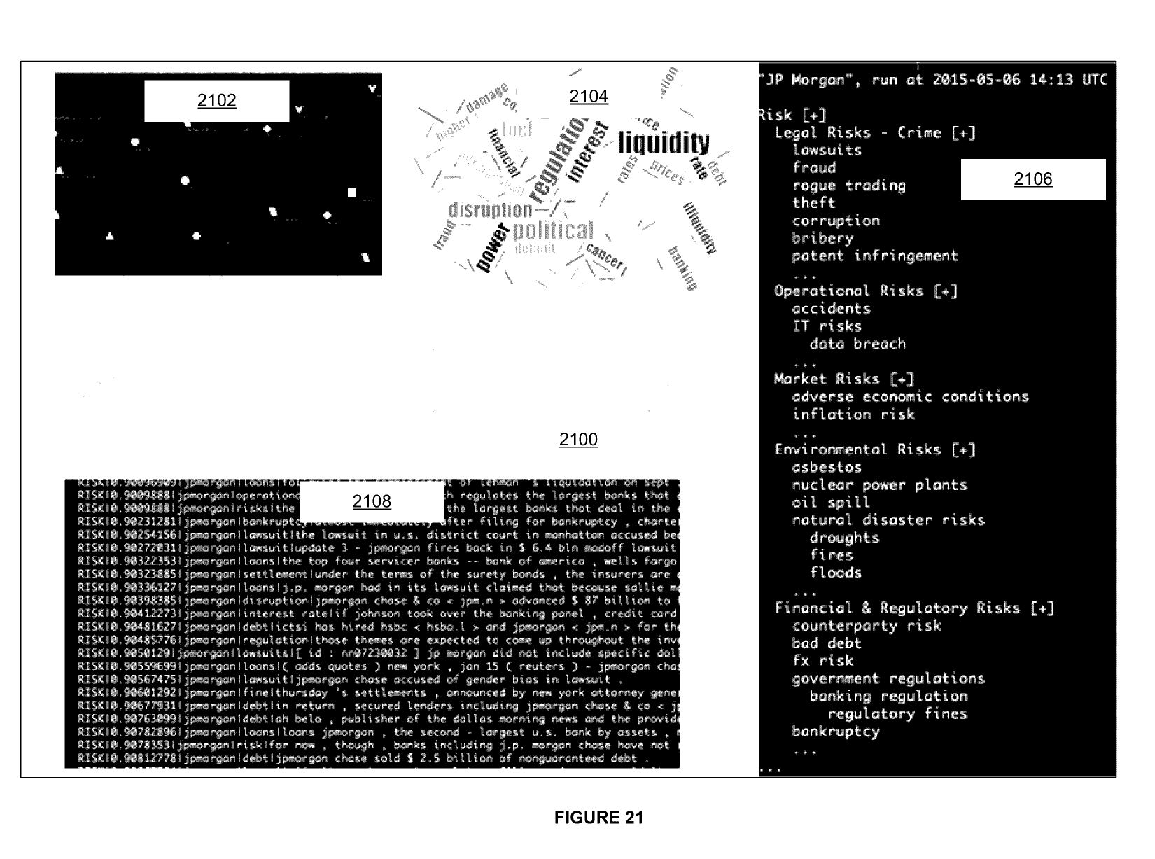

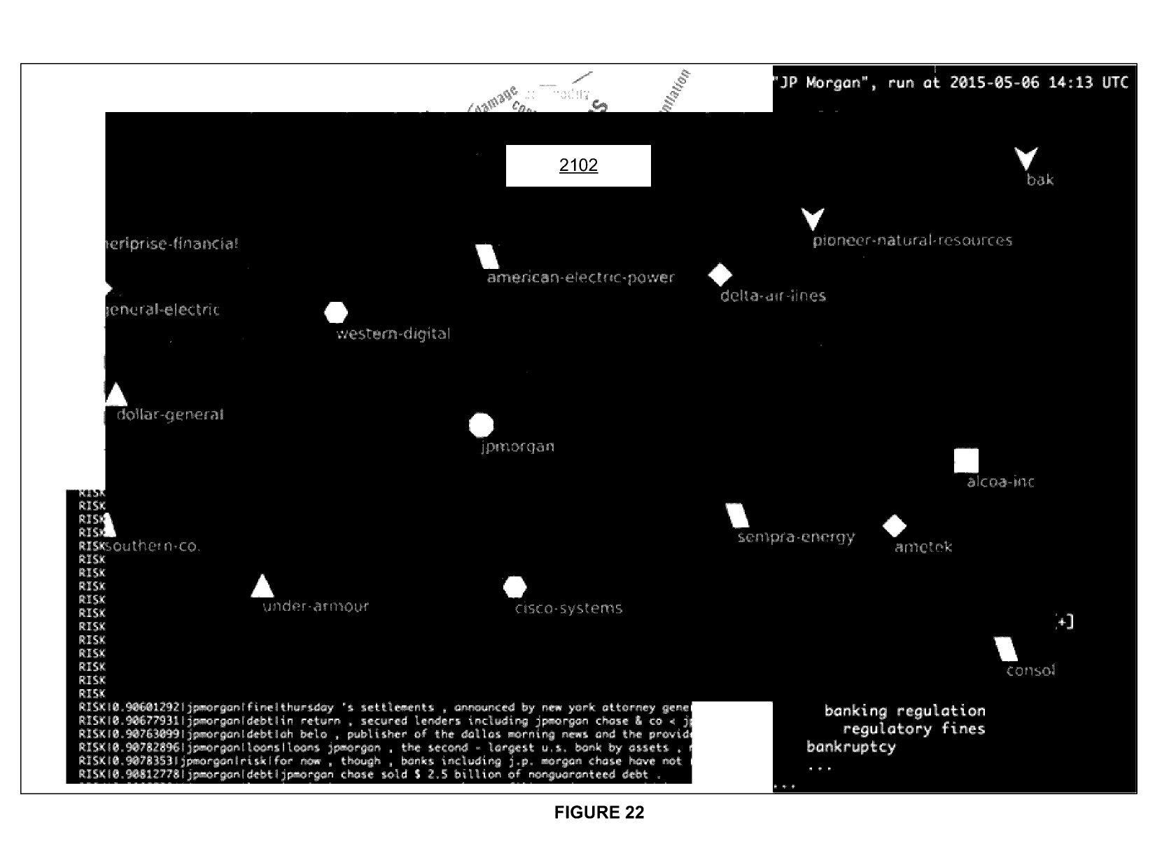

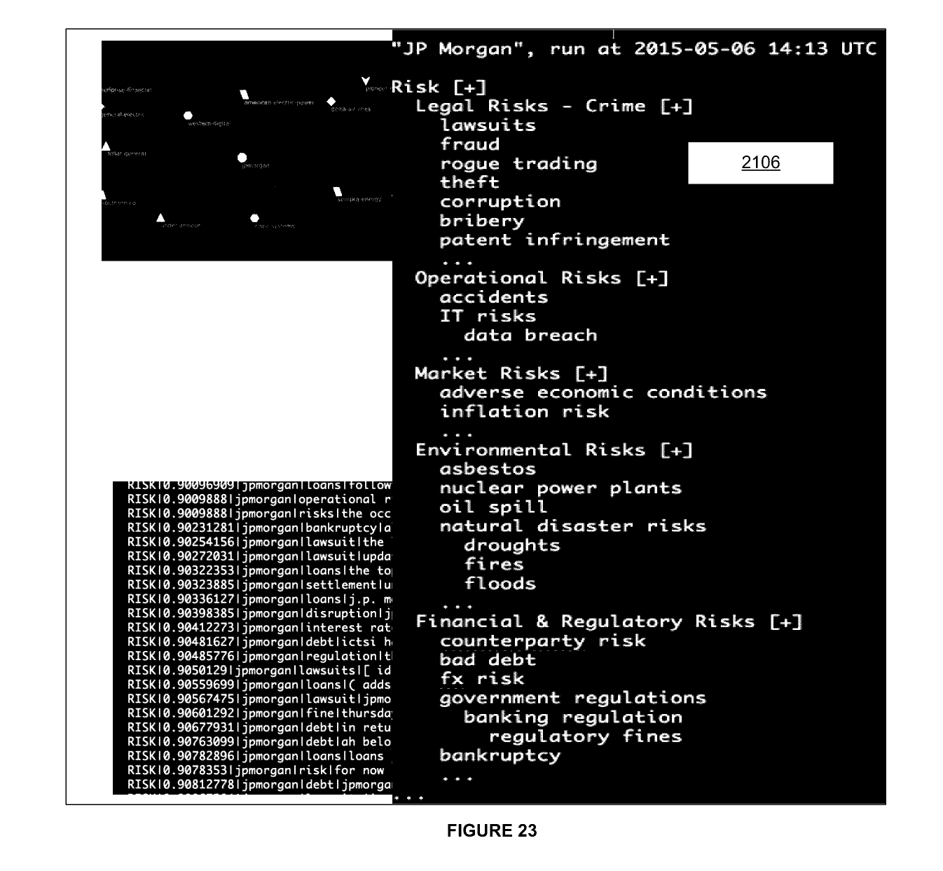

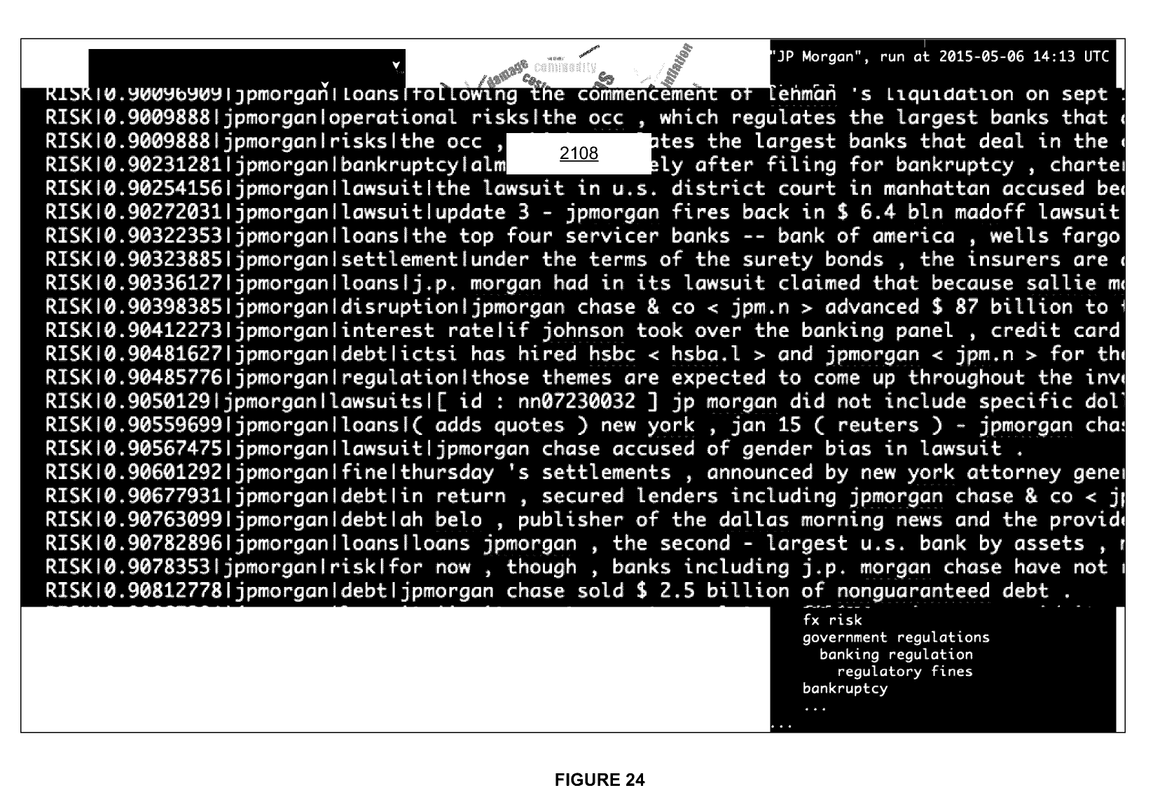

FIGS. 21-24 provide another embodiment of a graphical user interface called the 360 Risk View 2100 for JP Morgan Chase. The 360 Risk View 2100 comprises an entity web visualization 2102 that shows the relatedness of entities in one or more business areas or supply chains and is shown in more detail in FIG. 22. A word cloud 2104 shows the relative importance or frequence of occurrence of terms or risks associated with an entity. A list of risks 2106 provides detailed risk information on general and idiosyncratic risks for an entity and is shown in greater detail in FIG. 23. A detailed risk log 2108, shown in FIG. 24, shows instances where an entity and risk have been identified and also provides a quantitative score associated with the entity-risk pairing.

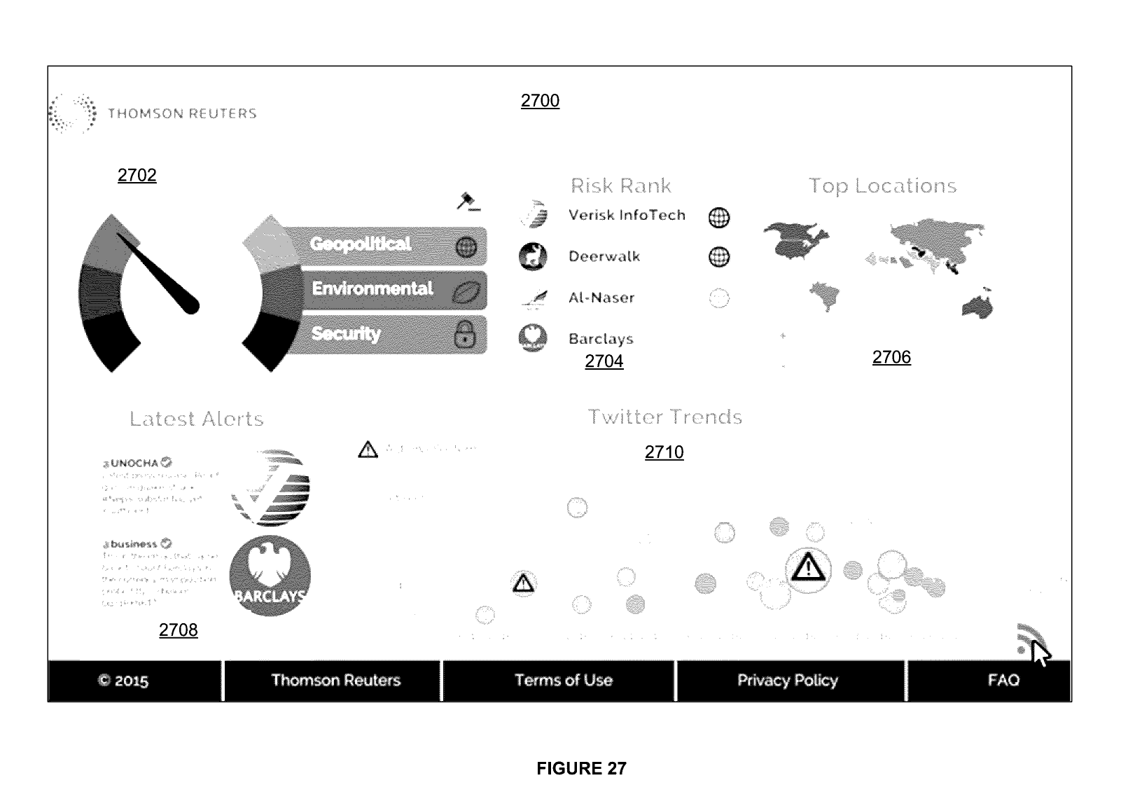

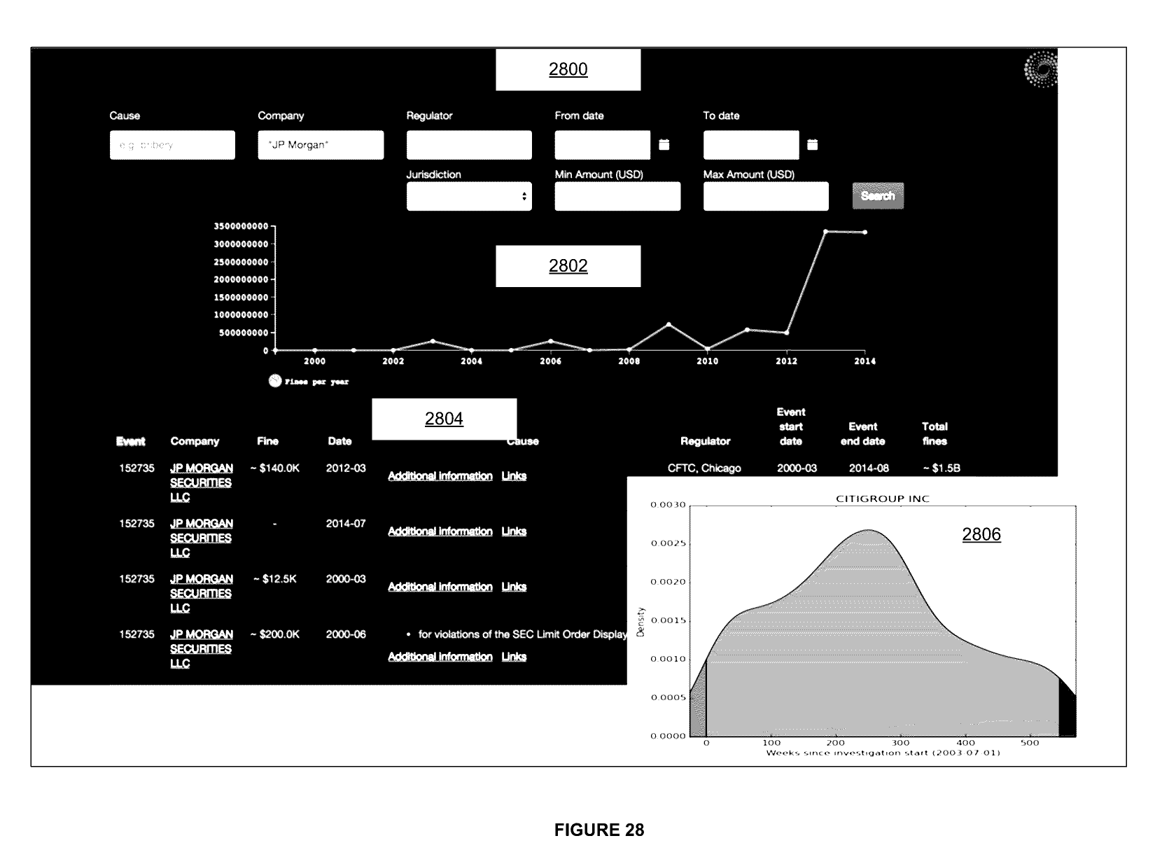

With reference now to FIG. 27, an entity risk dashboard 2700 is provided. The dashboard 2700 enables a user to view graphical representations of risks associated with a particular entity. The dashboard 2700 also enables a user to view, receive, and interact with alerts 2708 related to identified risks. A risk meter 2702 provides a graphical representation of the level of risk associated with a certain risk type as a color on a scale for risks such as labor and legal, geopolitical, environmental, and security. A risk rank 2704 provides a user with a list of the highest risks for a set of entities. A location risk chart 2706 indicates the top risk types and the level of the risk for different geographical regions. A trend chart 2710 indicates the type and level of risk from a certain information source, such as Twitter, and may also provide an indication as to which of the risks require action or user attention. In another view, risk view 2800, shown in FIG. 28, a user may view specific risk events for an entity. In the risk view 2800 risk events for “fines” associated with an entity are shown. The chart 2802 indicates the amount of fines for each year in a defined time frame, but may also show the level of other selected risk types. Detail area 2804 may show specific risk events and additional details associated with those risk events. For example, the detail area 2804 for “fine” type risk events may show fines, event numbers, entities, fine amounts, cause, additional information, levying agency, event start and end dates, and total fines. Additional information such as the number of mentions of the risk event may be shown in a graph 2806 when selected by a user.

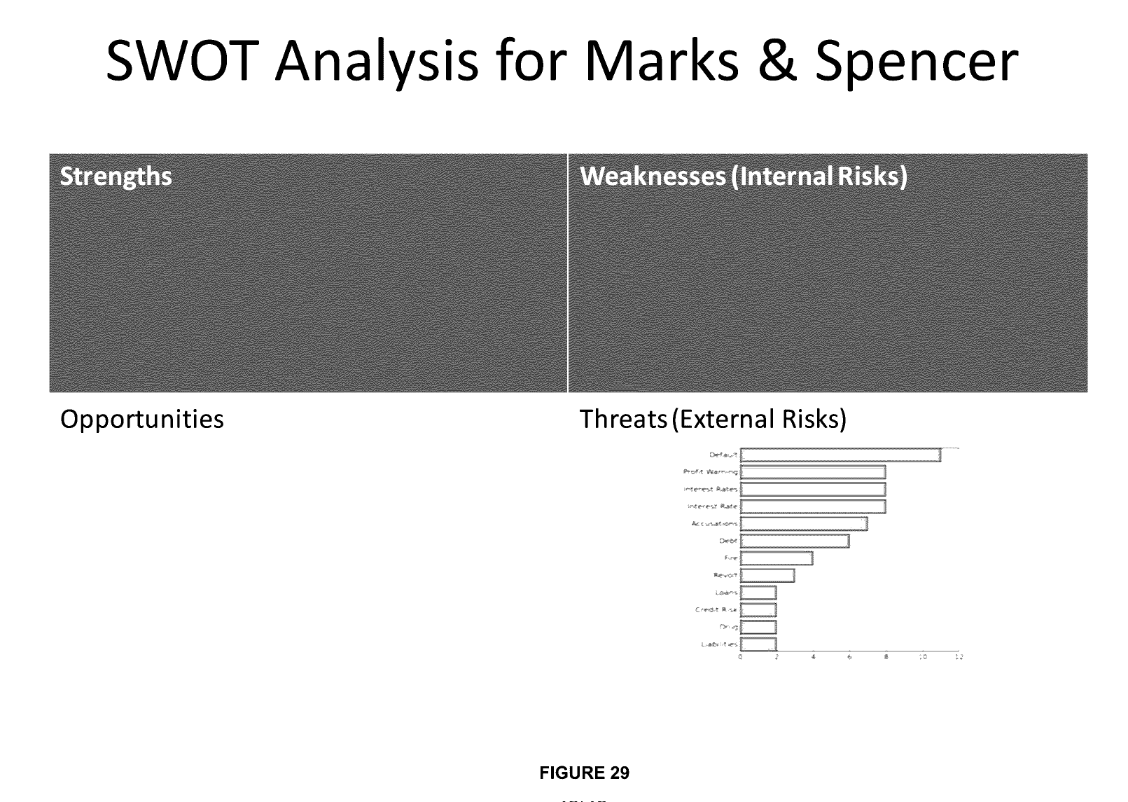

With reference to FIG. 29, the present invention may also take identified entity-risk information and generate a strength weakness opportunity threat (SWOT) chart for an entity. The SWOT chart may show the specific identified risks and the category those risks fall into. For example, the chart may show a list of external risks as threats and a list of internal risks as weaknesses as identified by the system.

While the invention has been described by reference to certain preferred embodiments, it should be understood that numerous changes could be made within the spirit and scope of the inventive concept described. In implementation, the inventive concepts may be automatically or semi-automatically, i.e., with some degree of human intervention, performed. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

We claim:

1. A computer-based system for generating a risk register relating to a named entity comprising:
a computing device having a processor in electrical communication with a memory, the memory adapted to store data and instructions for executing by the processor;
a risk database accessible by the computing device and having stored therein a set of risk types based on an induced taxonomy of risk types previously derived at least in part upon operation of a machine learning module;
an input adapted to receive a set of source data, the set of source data being in electronic form and representing textual content comprising potential risk phrases;
an entity-risk relation classifier adapted to identify and extract entity-risk relations from the set of source data, the entity-risk relation classifier comprising:
a risk tagger adapted to identify in the set of source data a set of risk candidates (rᵢ) based on the set of risk types; and
an entity tagger adapted to identify mentions of entity names (cᵢ) in the set of source data;
wherein the entity-risk relation classifier maps the identified set of risk types to the identified entity names to generate a set of tuples [ENTITY_{c};RISKᵣ]; and
a risk register aggregator adapted to generate a first risk register based on the set of tuples associated with a first entity.

2. The system of claim 1 wherein the identified names are stored in a entity index and the first risk register is associated with ENTITY_{cl}, defined as the set of all risks l . . . r . . . |R| where the entity index (c) is the same.

3. The system of claim 1 wherein the set of source data received comprises one or more of: an indexed search; a news archive; a news feed; structured data sets; unstructured data sets; social media content; regulatory filings.

4. The system of claim 1 wherein the entity-risk relation classifier maps the set of risk types to the entity names (cᵢ) in the set of source data to generate the set of tuples, the results comprising candidate risk exposure relationship tuples.

5. The system of claim 1 wherein the entity-risk relation classifier is further adapted to filter the set of tuples to eliminate false positive tuples.

6. The system of claim 1 further comprising an output adapted to generate and transmit a risk alert in response to an update to the first risk register.

7. The system of claim 1 wherein the entity-risk relation classifier is adapted to map the set of risk types to a plurality of entity names (cₗ . . . cₙ) to generate a plurality of sets of tuples (tₗ . . . tₙ) for each of the entity names and the risk register aggregator is further adapted to generate a plurality of risk registers (rrₗ . . . rrₙ) respectively associated with entity names (cₗ . . . cₙ) and sets of tuples (tₗ . . . tₙ).

8. The system of claim 7 wherein the input is further adapted to receive a search query and to execute a risk search on the plurality of risk registers (rrₗ . . . rrₙ).

9. The system of claim 7 further comprising:
a risk register database adapted to store the plurality of risk registers (rrₗ . . . rrₙ); and
a search engine adapted to receive and execute a search query on the plurality of risk registers (rrₗ . . . rrₙ).

10. The system of claim 1 further comprising a user interface module adapted to generate for display a risk visualization interface representing aspects of the risk register.

11. The system of claim 1 wherein the entity-risk relation classifier is adapted to identify and extract entity-risk relation mentions by using a set of purpose-defined features for risk sentence classification implemented as a Support Vector Machine (SVM).

12. The system of claim 11 wherein the Support Vector Machine (SVM) is trained and wherein the set of purpose-defined features is derived from a corpus of text to inform classification based on a machine learning process.

13. The system of claim 11 wherein the set of purpose-defined features includes a tree kernel.

14. The system of claim 1 wherein the entity-risk relation classifier further comprises:
a supply chain risk tagger adapted to identify supply chain relationships between one or more companies identified by the entity tagger and to identify in the set of source data a set of supply risk candidates (srᵢ) based on a set of supply risk types associated with supply chain risks;
wherein the first risk register comprises a tuple representing a supply risk type.

15. The system of claim 13 further comprising a user interface module adapted to generate for display a risk visualization interface representing a supply risk type of the first risk register.

16. The system of claim 1 further comprising a risk presentation module adapted to automatically generate a representation of risk for inclusion in a user-defined document.

17. The system of claim 15 wherein the user-defined document is one of: an SEC filing; a regulatory filing; a power point presentation; a SWOT diagram; a supply-chain cluster diagram; editable text document.

18. The system of claim 1 wherein the entity is selected from one of the group consisting of: a company; and a person.

19. A method for generating a risk register relating to a named entity comprising:
receiving input from an indexed search and a news archive;
creating from the input a risk taxonomy with risk types by a machine learning module;
mapping the risk types to the named entity identified in the news archive, the results comprising candidate risk exposure relationship tuples;
filtering the mapping results to eliminate false positive tuples; and
generating in response to the identified tuples the risk register.

20. The method of claim 19 further comprising generating a risk alert in response to an update to the risk register.

21. The method of claim 19 further comprising performing a risk search on the risk register.

22. The method of claim 19 further comprising displaying a risk visualization by representing aspects of the risk register.
